(19) United States
(12) Patent Application Publication
(10) Pub. No.: US 2004/0109197 A1
(43) Pub. Date: Jun. 10, 2004

(54) Apparatus and method for sharing digital content of an image across a communications network

(76) Inventors: Isabelle Gardaz, Penthaz (CH); Benoit Gennart, Lausanne (CH); Nicole Sergent, Rennaz (CH); Joaquin Tarraga, Lausanne (CH); Gregory Casey, Annapolis, MD (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 10/412,010

(22) Filed: Apr. 11, 2003

Related U.S. Application Data
(63) Continuation-in-part of application No. 10/163,243, filed on Jun. 5, 2002.
(63) Continuation-in-part of application No. 10/235,573, filed on Sep. 5, 2002.

(51) Int. Cl. G06F 13/00; G06F 15/00; G06F 15/167; G06F 12/14; H04N 1/393

(52) U.S. Cl. 358/1.15; 358/1.2; 709/213; 713/201; 358/451

(57) ABSTRACT

Methods and systems consistent with the present invention provide an image processing and sharing system that includes a first computer operably connected to a second computer on a network. The methods and systems allow an image on the first computer to be shared across the network with the second computer. The methods and systems generate a web page on the first computer, generate a multi-resolution representation of an identified image, associate the multi-resolution representation with the web page, provide to the second computer controlled access to the multi-resolution representation via the web page on the first computer, and provide an output image associated with the multi-resolution representation to the second computer when the web page is accessed by the second computer.

### CROSS-REFERENCE TO RELATED APPLICATIONS

This application is a continuation-in-part of U.S. patent application Ser. No. 10/163,243, entitled “Parallel Resampling of Image Data,” filed on Jun. 5, 2002; and is a continuation-in-part of U.S. patent application Ser. No. 10/235,573, entitled “Dynamic Image Repurposing Apparatus and Method,” filed on Sep. 5, 2002, both of which are incorporated herein by reference to the extent allowable by law.

### FIELD OF THE INVENTION

This invention relates to image processing and transfer. In particular, this invention relates to sharing digital content of an image between users across a communications network.

### BACKGROUND OF THE INVENTION

Digital imaging devices with image capture capabilities, such as digital cameras, typically allow a person to download a captured digital image to a computer for storing, viewing, and sharing of the digital image with another person, such as a family member, colleague or friend, over a communication network like the internet. With the increased availability of low cost digital imaging devices, the demand for sharing digital images across a communication network has increased dramatically. But conventional systems and methods for sharing a digital image or digital content (e.g., a portion of the digital image) from one person to another person (e.g., peer-to-peer) have several deficiencies.

For example, one conventional system for sharing of digital images across a communication network requires that each digital image be uploaded in its entirety from a client computer on the network to a centralized server for storage and for distribution to another client computer on the network. Thus, in this system both client computers require a connection to the centralized server to upload (e.g., access) or to download the digital content from the centralized server. Uploading or downloading a high resolution digital image (e.g., 2048×2048 pixels) typically requires a significant amount of time. The person uploading the digital image also looses control over the digital image once it is transferred to the centralized server. Furthermore, the centralized server is typically required to create and store a low resolution copy of each digital image on the centralized server to accommodate potential low-bandwidth connections with a client computer seeking to access any respective digital image. Thus, due to storage and access constraints, typical centralized servers are not able to provide digital images in multiple formats.

A second conventional system for sharing images uses a centralized server as a filter (e.g., like a pass-through server) between the client computer serving the digital image and other client computers on the network. The centralized server authenticates a user of a client computer, searches for digital images on other client computers in response to a request from the user, and connects the client computer of the user to the other client computers. Thus, this system requires that each user provide personal information to the centralized server for authentication. In addition, each client computer on the network is required to have a client application and connection to the centralized server, which limits the ability of a user to share images with others across the network and slows down the communication for the user making review of hi-resolution digital images is very time-consuming. Moreover, a user seeking digital images cannot choose which other client computers are searched and, thus, may receive unwanted digital images responsive to the request. Furthermore, the client computer that is serving digital images cannot control the other client computers and, thus, is required to have a large memory to support delivery of hi-resolution digital images to slower client computers. As a result, the typical client computer not able to provide digital images in multiple formats.

A third conventional system for sharing digital content allows one client computer to serve digital images directly to a second client computer across a network. But each client computer in this system is required to host an imaging application for serving or viewing shared digital images. Thus, a person on one client computer is not able to share digital images with another client computer, unless that other client computer has the same imaging application. In addition, the client computer serving digital images in this system requires large amounts of memory and processing power. These problems are especially intense for thin client computers, such as laptop computers, workstations, Personal Digital Assistants (PDAs), tablet computers, cameras, printers, cellular phones, or any client computer that runs an operating system like Windows, Macintosh, or Linux. Thin client computers typically do not have enough memory, processing power, or connection bandwidth to serve or view (e.g., share) multiple hi-resolution digital images across a network. Furthermore, the thin client computers typically are not able to share digital images with other client computers running different operating systems.

Therefore, a need has long existed for methods and apparatus that overcome the problems noted above and others previously experienced.

### SUMMARY OF THE INVENTION

Methods and systems consistent with the present invention provide an image sharing server that allows an image stored on one computer on a network to be shared with a second computer across the network without requiring the one computer to upload or loose control of the image and without requiring the second computer to have excessive amounts of processing power or storage.

In accordance with methods and systems consistent with the present invention, a method is provided in an image processing system that is operably connected to a client computer across a network. The image processing system has a storage device that includes an image. The method comprises generating a web page, generating a multi-resolution representation of an identified image, associating the multi-resolution representation with the web page, providing to the second computer controlled access to the multi-resolution representation via the web page on the first computer, and providing, via the first computer, and providing an output image associated with the multi-resolution representation to the requesting client computer when the web page is accessed by the requesting client computer.

In one implementation, the image processing system has an associated firewall for controlling access to the image processing system on the network and an image sharing server operably connected to the client computer on the network via a gateway. In this implementation, the method further includes registering the image sharing server with the gateway, and generating an address of the web page to include an address associated with the gateway and an identification associated with the image sharing server, and providing the address of the web page to the second computer such that the web page on the first computer is accessible by the second computer based on the address. The method may further include providing the gateway with a first request from the image sharing server to access the web page, receiving a response to the first request from the gateway, determining whether the response includes a client request from the second computer to access the web page, and providing the output image to the client computer when the response includes a client request to access the web page.

In accordance with articles of manufacture consistent with the present invention, a machine-readable medium is provided. The machine-readable medium contains instructions for controlling an image processing system to perform a method. The method comprises generating a web page on a first computer operably connected on a network, generating a multi-resolution representation of an identified image stored in association with the first computer, associating the multi-resolution representation with the web page, providing to the second computer controlled access to the multi-resolution representation via the web page on the first computer, and providing, via the first computer, an output image associated with the multi-resolution representation to the second computer when the web page is accessed by the second computer.

Other systems, methods, features, and advantages of the present invention will be or will become apparent to one with skill in the art upon examination of the following figures and detailed description. It is intended that all such additional systems, methods, features, and advantages be included within this description, be within the scope of the invention, and be protected by the accompanying claims.

### BRIEF DESCRIPTION OF THE DRAWINGS

The accompanying drawings, which are incorporated in and constitute a part of this specification, illustrate an implementation of the present invention and, together with the description, serve to explain the advantages and principles of the invention. In the drawings:

FIG. 1 depicts a block diagram of an image processing and sharing system suitable for practicing methods and implementing systems consistent with the present invention.

FIG. 2 depicts a block diagram of the image processing system of FIG. 1 operably configured to share digital content of an image with a client computer across a network when the image processing system does not have a firewall.

FIG. 3 depicts a flow diagram of a process performed by an image sharing server of the image processing system to generate a multi-resolution representation of an identified image and to generate a web page to share digital content of the identified image with the client computer across the network.

FIG. 4A depicts an exemplary user interface displayed by a web browser of the imaging processing system after accessing the web page generated by the image sharing server.

FIG. 4B depicts an exemplary directory window displayed by the image processing system to allow an image to be identified.

FIG. 5 illustrates an example of a multi-resolution representation in which five blocks have been written.

FIG. 6 shows an example of a node/block index allocation for a 1, 2, 3, 4-node file having 3×3 image tiles.

FIG. 7 depicts an exemplary user interface displayed by the web browser of the image processing system after accessing the web page on the image processing system and receiving an output image from the image sharing server.

FIG. 8 depicts an exemplary user interface that the image sharing server causes the web browser of the image processing system to display in response to the image addressing server receiving an indication that the output image has been selected.

FIG. 9 illustrates depicts a flow diagram of steps executed to generate an output image to share with the client computer.

FIG. 10 graphically illustrates an example of the properties of discrete line approximations that are used by the resampling tool of the image processing system to resize the output image.

FIG. 11 shows an example of resampled tiles in relation to source tiles of the selected image, as determined by the resampling tool running in the image processing system when resizing the output image.

FIG. 12 depicts a flow diagram showing processing performed by the resampling tool running in the image processing system in order to resample source tiles.

FIG. 13 shows a second example of resampled tiles in relation to source tiles of the selected image, as determined by the resampling tool running in the image processing system of the selected image.

FIG. 14 depicts a flow diagram showing processing performed by the resampling tool running in the image processing system in order to resample source tiles of the selected image according to the second example shown in FIG. 13.

FIG. 15 depicts an expanded view of the source tile BI shown in FIG. 13.

FIG. 16 depicts a flow diagram illustrating an exemplary process performed by the image sharing server to share an image stored on the image processing system across the network with the client computer.

FIG. 17 depicts an exemplary user interface displayed by the web browser of the client computer after accessing the web page on the image processing system and receiving the output image from the image sharing server.

FIG. 18 depicts an exemplary user interface that the image sharing service causes the web browser of the client computer to display in response to the image addressing server receiving an indication that the output image is selected.

FIG. 19 depicts an exemplary user interface displayed by the web browser of the client computer in response to the image sharing server resizing the selected output image to replace the selected output image to reflect a resize option from the client computer.

FIG. 20 depicts an exemplary user interface that the image sharing server causes the client computer to display in response to receiving a save option from the client computer.

FIG. 21 depicts an exemplary user interface that the image sharing server causes the client computer to display in response to receiving a download option from the client computer.

FIG. 22 depicts a block diagram of another embodiment of an image processing system operably configured to share digital content of an image with the client computer across the network when the image processing system has an associated firewall.

FIGS. 23A-C together depict a flow diagram illustrating an exemplary process performed by the image sharing server of FIG. 22 to share the image across the network with the client computer.

### DETAILED DESCRIPTION OF THE INVENTION

Reference will now be made in detail to two implementations in accordance with methods, systems, and products consistent with the present invention as illustrated in the accompanying drawings. The same reference numbers may be used throughout the drawings and the following description to refer to the same or like parts.

A. System Architecture

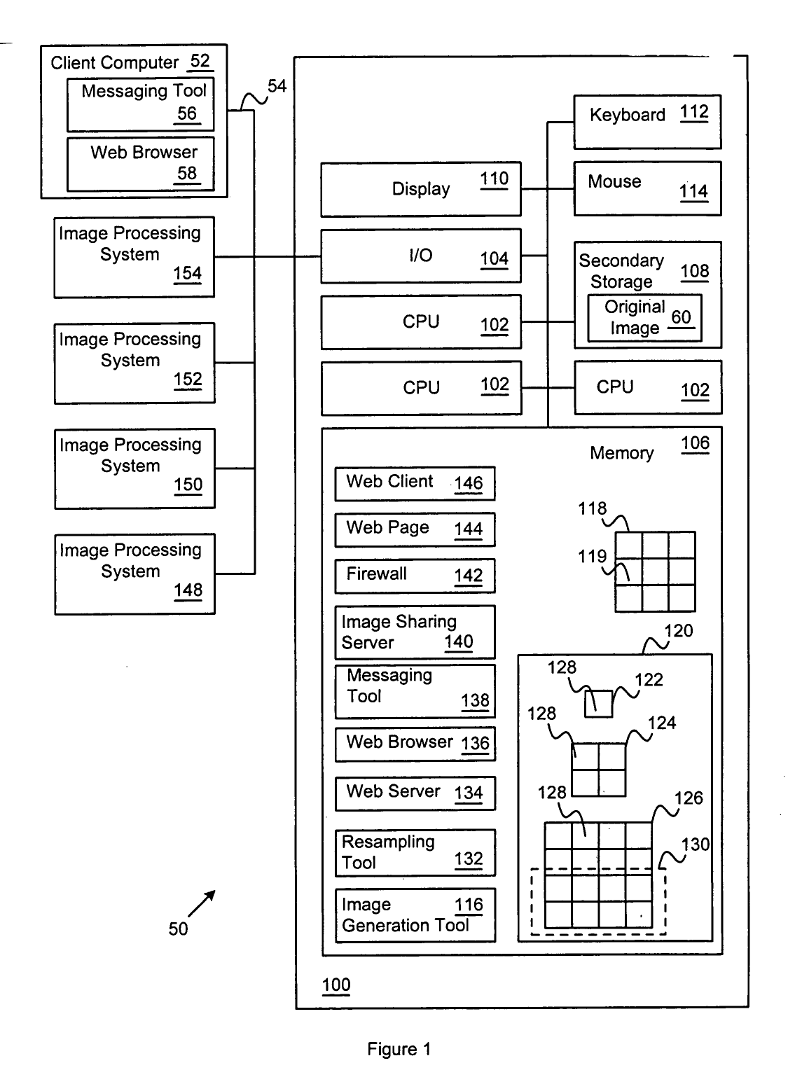

FIG. 1 depicts a block diagram of an image processing and sharing system 50 suitable for practicing methods and implementing systems consistent with the present invention.

The image processing and sharing system 50 includes a client computer 52 and an image processing system 100 that is operably connected to the client computer 52 across a network 54. Client computer 52 may be any general-purpose computer system such as an IBM compatible, Apple, or other equivalent computer. The network 54 may be any known private or public communication network, such as a local area network (“LAN”), WAN, Peer-to-Peer, or the Internet, using standard communications protocols. The network 54 may include hardwired as well as wireless branches.

The client computer 52 includes a messaging tool 56, which may be any known e-mail tool or instant messaging tool that is capable of receiving a message across the network 54. The client computer 52 also includes a web browser 58, such Microsoft™ Internet Explorer or Netscape Navigator, that is capable of accessing a web page across the network 54. As explained in detail below, the image processing system 100 is operably configured to share an original image 60, or digital content of the original image 60, with the client computer 52 across the network 54.

The image processing system 100 includes at least one central processing unit (CPU) 102 (three are illustrated), an input output I/O unit 104 (e.g., for a network connection), one or more memories 106, one or more secondary storage devices 108, and a video display 1 10. The image processing system 100 may further include input devices such as a keyboard 112 or a mouse 114. Image processing system 100 may be implemented on another client computer 52. In one implementation of the image processing system 100, the secondary storage 108 may store the original image 60. In another implementation, the original image 60 may be stored in memory 106. In yet another implementation, the original image 60 may be distributed between parallel data storage devices, such as secondary storage 108, memory 106, or another image processing system connected either locally to the image processing system 100 or to the image processing system 100 via the network 54. In this implementation, the original image 60 may be distributed between parallel data storage devices in accordance with the techniques set forth in U.S. Pat. No. 5,737,549, filed Apr. 7, 1998, entitled “Method And Apparatus For A Parallel Data Storage And Processing Server,” which is incorporated herein by reference.

The memory 106 stores an image generation program or tool 116, a resampling tool 132, a web server 134, a web browser 136, a messaging tool 138, and an image sharing server 140. The memory 106 may also store a firewall 142 to control access between network 54 and the image processing system 100. Each of 116, 132, 134, 136, 138, 140, 142 and 146 are called up by the CPU 102 from memory 106 as directed by the CPU 102. The CPU 102 operably connects the tools and other computer programs to one another using the operating system to perform operations as described hereinbelow.

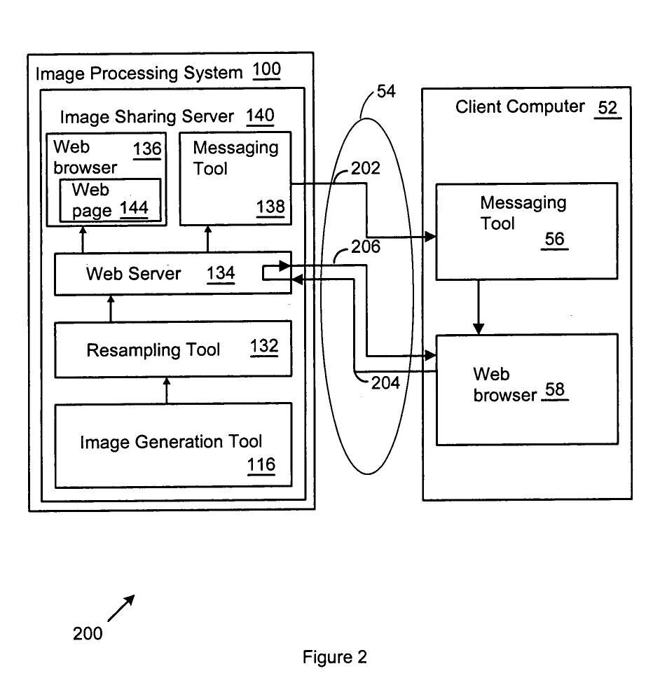

FIG. 2 depicts a block diagram of one implementation of the image processing system 100 operably configured to share digital content of the original image 60 with the client computer across the network 54. As shown in FIG. 2, the image sharing server 140 is operably configured to control the operation of the image generation tool 116, the resampling tool 132, the web server 134, the web browser 136, and the messaging tool 138 to share digital content of the original image 60 with the client computer 52 across the network 54 when the image processing system 100 does not have or use the firewall 142.

Returning to FIG. 1, image sharing serve may cause the image generation tool 116 to generate an output image 118 from a multi-resolution representation 120 of the original image 60. The output image 118 may be generated in response to a request from a user of the image processing system 100 to share the original image 60 with a person using the client computer 52. In one embodiment, the image generation tool 116 generates an output image 118 in accordance with the techniques set forth in U.S. patent application Ser. No. 10/235,573, entitled “Dynamic Image Repurposing Apparatus and Method,” which was previously incorporated herein by reference. As will be explained in more detail below, the multi-resolution representation 120 stores multiple image entries (for example, the image entries 122, 124, and 126). In general, each image entry is a version of the original image 60 at a different resolution and each image entry in the multi-resolution representation 120 is generally formed from image tiles 128. The image tiles 128 form horizontal image stripes (for example, the image stripe 1.30) that are sets of tiles that horizontally span an image entry.

As shown in FIG. 2, the resampling tool 132 is operably connected to the image generation tool 116 to resize a selected one of the image entries 122, 124, and 126 of the multi-resolution representation 120. To perform the resize, zoom, or pan function as explained below, the resampling tool resamples a source image divided into source tiles (e.g., image tiles 128 of the selected image entry 122, 124, or 126 provided by the imaging generation tool 116) to form a target image (e.g., the output image 118) from resampled tiles 119. The target image or output image 118 may need further processing by the image generation tool 116 before the output image 118 is shared with the client computer 52 as described below. In one embodiment, the resampling tool 132 resamples the source tiles to generate the target image or output image 118 in accordance with the techniques set forth in U.S. patent application Ser. No. 10/163,243, entitled “Parallel Resampling of Image Data,” which was previously incorporated herein by reference. Consistent with methods and systems disclosed herein, the resampling tool 132 may resample a source image (or the selected image entry 122, 124, or 126) to resize the source image to produce the output image 118 in a size requested by the client computer 52 that does not correspond to any of the image entries 122, 124, or 126 of the multi-resolution representation 120. Of course, the sampling tool 132 may be incorporated into the image generation tool 116.

As illustrated in FIG. 2, the web server 134 may be operably connected to the image generation tool 116 to allow, among other functions, a user of the image processing tool 100 to create and manage access to a web page (e.g., web page 144 of FIGS. 1 and 2) for sharing the original image 60 or digital content of the original image (e.g., output image 118) with client computer 52 in accordance with methods and systems consistent with the present invention. Web server 134 may be any known computer program or tool that utilizes a communication protocol, such as HTTP, to control access to, manage, and distribute information that form Web pages to a client (e.g., client computer 52) on network 54. Exemplary Web servers are Java Web Server, International Business Machines Corporation's family of Lotus Domino.RTM. servers and the Apache server (available from www.apache.org). The web server 134 is also operably connected to the web browser 136 of the imaging processing system 100. The web browser 136 allows the user to view and modify the web page 144 before access by the client computer 52 is granted by the image sharing server 140. Web browser 136 may be Microsoft™ Internet Explorer, Netscape Navigator, or other web-enabled communication tool capable of viewing an html page (e.g., a file written in Hyper Text Markup Language) or a web page (e.g., an html page with code to be executed by Web browser 136) having a network address, such as a Uniform Resource Locator (“URL”).

The messaging tool 138 is also operably connected to the web server 134 to communicate the network address of the web page 144, among other information, to the client computer 52 via a connection 202 on network 54. The messaging tool 138 may be any commercially available e-mail or instant messaging application. In one embodiment described in detail below, the client computer 52 may use the network address to send an access request to web server 134 via connection 204 on network 54. The web server 134 may then respond to the request via connection 206 on network 54.

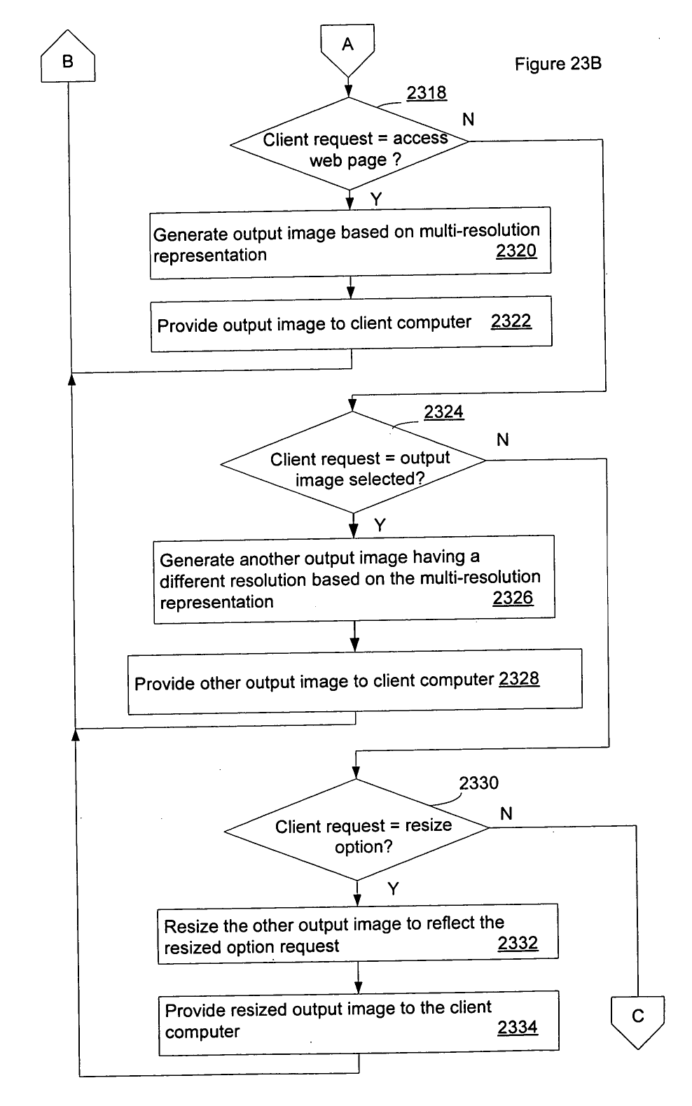

As shown in FIGS. 1 and 22, the memory 106 may also store a web client 146 that is used by the image sharing server 140 when the image processing system (e.g., 2202 of FIG. 22) has a firewall 142 that controls access to the image processing system 2200 on network 54.

As shown in FIG. 22, the web client 146 is operably connected between the web server 134 and the firewall 142. As further described below, the web client 146 may be operably configured to send network requests, such as an http or URL request, originating from the web server 134 to a router or gateway 2004 (see FIG. 22) that operably connects the image processing system 2200 to the client computer 52 via the network 54. The web client 146 is also configured to receive and interpret responses from the gateway 2004 for the web server 134.

The image processing system 100 may connect to one or more separate image processing systems 148-154, such as via network 54. For example, the I/O unit 104 may include a WAN/LAN or Internet network interface to support communications from the image processing system 148 locally or remotely. Thus, the image processing system 148 may take part in generating the output image 118 by generating a portion of the output image 118 based on the multi-resolution representation 120 or by resampling a selected one of the image entries 122, 124, 126 of the multi-resolution representation 120. In general, the image generation or resampling techniques explained below may run in parallel on any of the multiple processors 102 and alternatively or additionally separate image processing systems 148-154, and intermediate results (e.g., image stripes or resampled tiles) may be combined in whole or in part by any of the multiple processors 102 or separate image processing systems 148-154.

The image processing systems 148-154 may be implemented in the same manner as the image processing 100. Furthermore, as noted above, the image processing systems 148-154 may help generate all of, or portions of the output image 118. Thus, the image generation or the resampling may not only take place in a multiple-processor shared-memory architecture (e.g., as shown by the image processing system 100), but also in a distributed memory architecture (e.g., including the image processing systems 100 and 148-154). Thus the “image processing system” described below may be regarded as a single machine, multiple machines, or multiple CPUs, memories, and secondary storage devices in combination with a single machine or multiple machines.

In addition, although aspects of the present invention are depicted as being stored in memory 106, one skilled in the art will appreciate that all or part of systems and methods consistent with the present invention may be stored on or read from other computer-readable media, for example, secondary storage devices such as hard disks, floppy disks, and CD-ROMs; a signal received from a network such as the Internet; or other forms of ROM or RAM either currently known or later developed. For example, the multi-resolution representation 120 may be distributed over multiple secondary storage devices. Furthermore, although specific components of the image processing system 100 are described, one skilled in the art will appreciate that an image processing system suitable for use with methods and systems consistent with the present invention may contain additional or different components.

B. Generating A Web Page To Share An Image

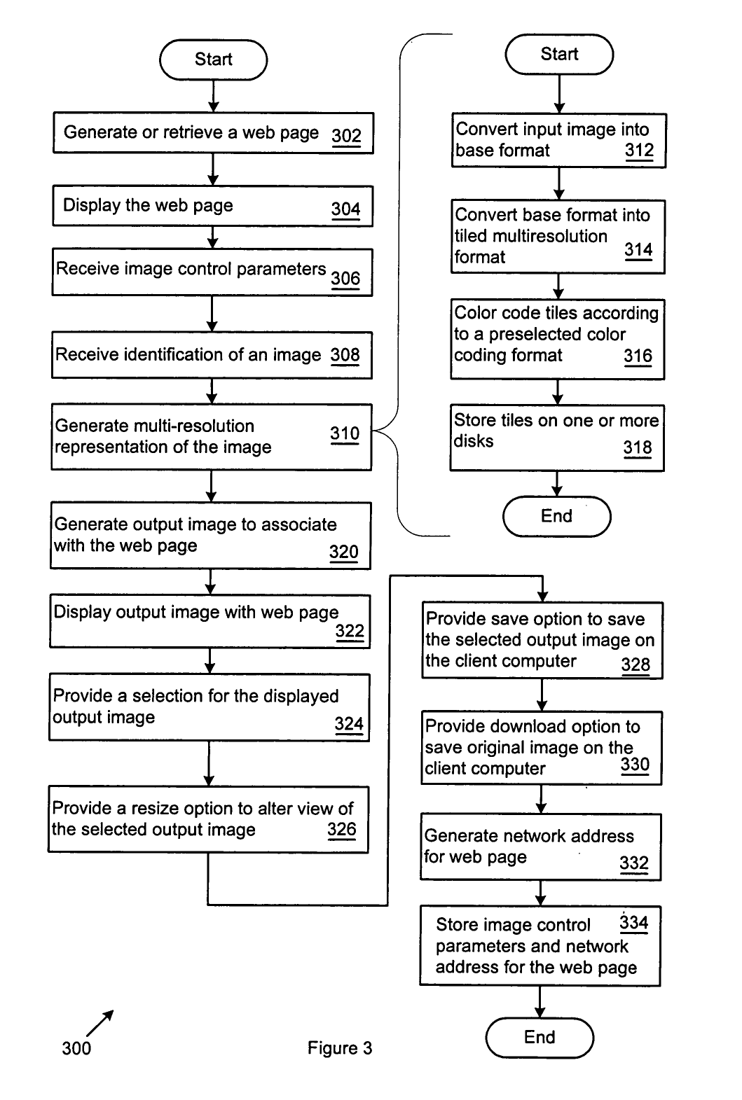

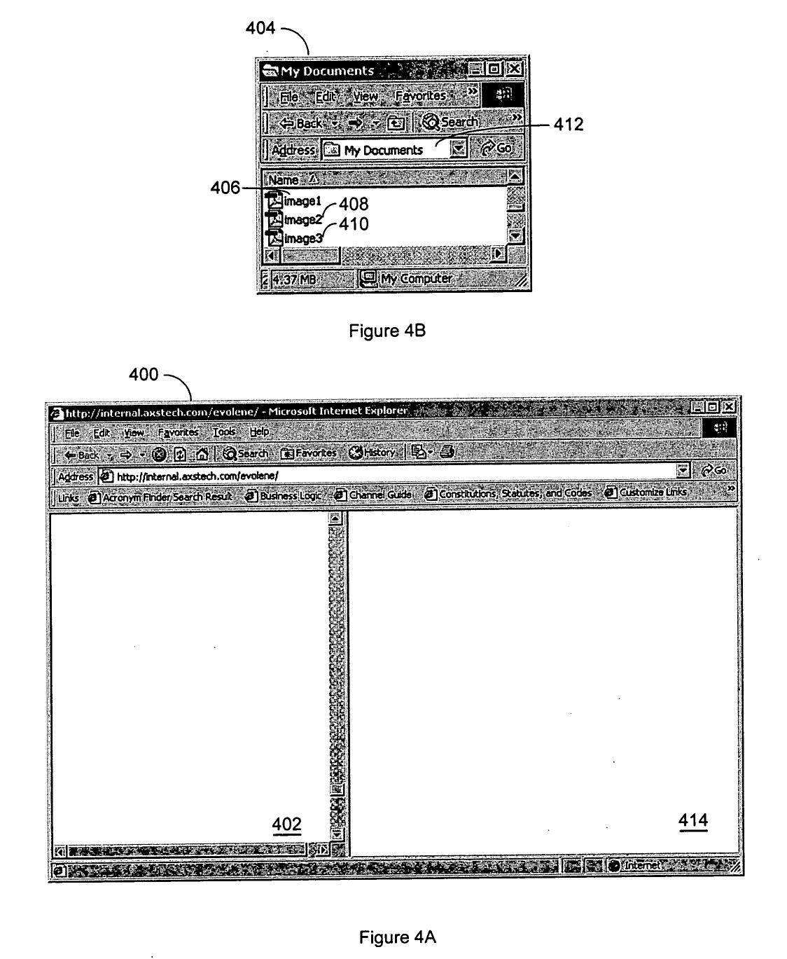

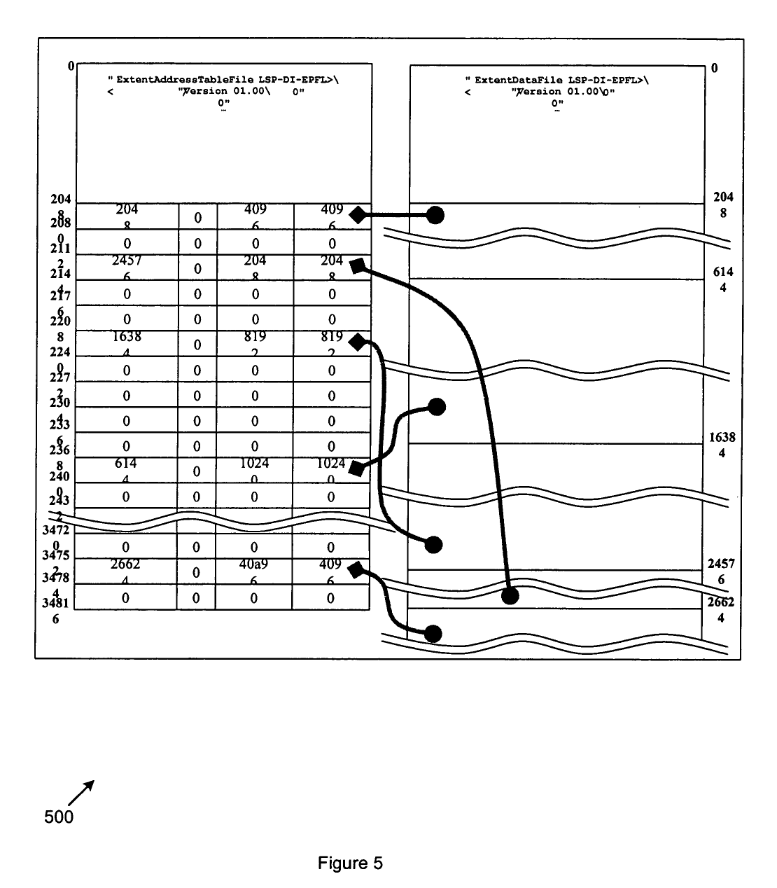

Turning to FIG. 3, that Figure presents a flow diagram of a process performed by the image sharing server 140 to generate a web page (e.g. web page 144) to share a selected image, such as digital content of original image 60, with the client computer 52 across the network 54. In particular, image sharing server 140 first causes web server 134 to generate web page 144 (Step 302) and display the web page 144 using web browser 136. (Step 304). For example, the image sharing server 140 may upon startup or upon a user request cause the web server 134 to generate and display a new or an existing html page or web page 144. FIG. 4A depicts an exemplary display 400 of web browser 136, which enables a person using the image processing system 100 to view the web page 144 before sharing the web page 144 with another person using the client computer 52. In the implementation shown in FIG. 4A, a panel 402 is displayed empty by the web browser 136 to reflect that no output image (e.g. output image 118) has been associated with the new web page 144 by the image sharing server 140. Alternatively, an existing web page (such as web page 144 once it has been saved by the web browser 136) may be displayed by the web browser 136 with any output images of an original image (e.g. output image 118 of original image 60 (See FIG. 1)) previously associated with the existing web page by the image sharing server 140. The image sharing server 140 may also cause web server 134 to generate another panel 414 to view or to edit a selected output image shared with the client computer 52 as discussed below.

The image sharing server 140 may also receive image control parameters (Step 306). The image control parameters are associated with the web page 144 and include a starting resolution or size of an image that may be associated with the web page 144 by the image sharing server 140. For example, the starting resolution or display size may be 125×125 pixels or 200×200 pixels, which may be less or greater than the resolution of a single image tile 128. The starting resolution may be indicated to the image sharing server 140 using any known data input technique, such as a drop down menu on web browser 136, a file read by the image sharing server 140 upon startup or user input via keyboard 112 or mouse 114. As explained in further detail below, when the web page 144 is accessed by the client computer 52, the image sharing server provides an output image 118 that has the starting resolution or size specified by the image control parameters for the web page 144. Thus, a person using client computer 52 initially views on panel 402 (See FIG. 4A) the output image 118 corresponding to the original image 60 but having the starting resolution.

The image control parameters may also include an expanded view size, which may be indicated to the image sharing server using any known data input technique, such as those identified for indicating the starting resolution of an image. As discussed in further detail below, when a request to view an image in expanded view is received by the image sharing server 140 from the client computer, the image sharing server 140 sizes the image to reflect the expanded view size specified by the image control parameters for the web page 144 in accordance with methods and systems consistent with the present invention. Thus, a person using the image processing system 100 is able to control the digital content of the image (e.g., original image 60) that is shared with another person on client computer 52.

In one implementation, the image control parameters may be predefined such that the image sharing server 140 need not perform step 306. For example, the image control parameters may be predefined such that the starting resolution corresponds to one of the image entries (e.g., image entries 122, 124, and 126) of the multi-resolution representation 120 of the image to be shared and the expanded view size corresponds to another of the image entries.

Next, the image sharing server 140 receives an identification of an image to be shared. (Step 308). The image sharing server 140 may receive the identification of the image to be shared via any known data input techniques, such as a via a file (not shown in figures) read by the image sharing server 140 upon startup or via user keyboard 112 or mouse 114 input. For example, FIG. 4B depicts an exemplary directory window 404 displayed by image processing system 100. In this instance, a person may use mouse 114 to cause the image processing tool 100 to generate the directory window 404 to display the names of original images (e.g., 406, 408, and 410) stored at address location 412 on secondary storage 108. Using the mouse 114, the user may subsequently select one of the original image names 406, 408, and 410, and then “drag and drop” the selected original image name 406, 408, or 410 on to the panel 402 of displayed web page 144 to provide the identification of the selected image to the image sharing server 140. Of course, other manners of selecting an image may also be utilized under the present invention.

After receiving the identification of the image to be shared, the image sharing server 140 generates the multi-resolution representation 120 of the identified image. (Step 310). To generate the multi-resolution representation 120 of the identified image (e.g., original image 60), the image sharing server may invoke the image processing system 100 to perform the sub-process steps 312, 314, 316, and 318 shown in FIG. 3. These steps, however, may be performed by any one or combination of the image processing systems 100, 148-154.

To generate the multi-resolution representation 120, the image processing system 100 when invoked by the image sharing server 140 first converts the identified image (e.g., original image 60) into a base format. (Step 312). The base format specifies an image coding and a color coding. Each image coding provides a specification for representing the identified image as a series of data bits. Each color coding provides a specification for how the data bits of the identified image represent color information. Examples of color coding formats include Red Green Blue (RGB), Cyan Magenta Yellow Key (CMYK), and the CIE L-channel A-channel B-channel Color Space (LAB). Thus, the base format may be an uncompressed LAB, RGB, or CMYK format stored as a sequence of m-bit (e.g., 8-, 16-, or 24-bit) pixels.

Subsequently, the identified image, in its base format, is converted into a tiled multi-resolution representation 120. (Step 314). A detailed discussion is provided below, however, some of the underlying concepts are described at this juncture. The multi-resolution representation 120 includes multiple image entries (e.g., the entries 122, 124, 126), in which each image entry is a different resolution version of the identified original image 60. The image entries are comprised of image tiles that generally do not change in size. Thus, as one example, an image tile may be 128 pixels×128 pixels, and an original 1,024 pixel×1,024 pixel image may be formed by 8×8 array of image tiles.

Each image entry in the multi-resolution representation 120 is comprised of image tiles. For example, assume that the multi-resolution representation 120 stores a 1,024×1,024 image entry, a 512×512 image entry, a 256×256 image entry, a 128×128 image entry, and a 64×64 image entry, for example. Then, the 1,024×1,024 image entry is formed from 64 image tiles (e.g., 8 horizontal and 8 vertical image tiles), the 512×512 image entry is formed from 16 image tiles (e.g., 4 horizontal and 4 vertical image tiles), the 256×256 image entry is formed from 4 image tiles (e.g., 2 horizontal and 2 vertical image tiles), the 128×128 image entry is formed from 1 image tile, and the 64×64 image entry is formed from 1 image tile (e.g., with the unused pixels in the image tile left blank, for example).

The number of image entries, their resolutions, and the image tile size may vary widely between original images, and from implementation to implementation. The image tile size, in one embodiment, is chosen so that the transfer time for retrieving the image tile from disk is approximately equal to the disk latency time for accessing the image tile. Thus, the amount of image data in an image tile may be determined approximately by T * L, where T is the throughput of the disk that stores the tile, and L is the latency of the disk that stores the tile. As an example, an 50 KByte image tile may be used with a disk having 5 MBytes/second throughput, T, and a latency, L, of 10 ms.

The multi-resolution representation 120 optimizes out-of-core data handling, in that it supports quickly loading into memory only the part of the data that is required by an application (e.g., the image generation tool 116 or the resampling tool 132). The multi-resolution representation 120 generally, though not necessarily, resides in secondary storage (e.g., hard disk, CD-ROM, or any online persistent storage device), and processors load all or part of the multi-resolution representation 120 into memory before processing the data.

The multi-resolution representation 120 is logically a single file, but internally may include multiple files. In one implementation, the multi-resolution representation 120 includes a meta-file and one or more nodes. Each node includes an access-file and a data file.

The meta-file includes information specifying the type of data (e.g., 2-D image, 3-D image, audio, video, and the like) stored in the multi-resolution representation 120. The meta-file further includes information on node names, information characterizing the data (e.g., for a 2-D image, the image size, the tile size, the color and image coding, and the compression algorithm used on the tiles), and application specific information such as geo-referencing, data origin, data owner, and the like.

Each node data file includes a header and a list of image tiles referred to as extents. Each node address file includes a header and a list of extent addresses that allowing a program to find and retrieve extents in the data file.

The meta-file, in one implementation, has the format shown in Table 1 for an exemplary file ila0056e.axf:

| Line | Entry | Explanation |
|---|---|---|
| 1 | [File] | Identifies file type |
| 2 | Content = Image | Identifies file content as an image |
| 3 | Version = 1.0 | This is version 1 of the image |
| 4 | | |
| 5 | [Nodes] | There is one node |
| 6 | localhost \| \| ila0056e.axf | Node is stored on local host and named |
| | | ila0056e.axf |
| 7 | | |
| 8 | [Extentual] | |
| 9 | Height = 128 | Tile height |
| 10 | Width = 128 | Tile width |
| 11 | | |
| 12 | [Size] | |
| 13 | Height = 2048 | Image height, at highest resolution |
| 14 | Width = 2560 | Image width, at highest resolution |
| 15 | | |
| 16 | [Pixual] | |
| 17 | Bits = 24 | Bits pet pixel |
| 18 | RodCone = Color | Color image |
| 19 | Space = RGB | Color coding, red, green, blue color |
| | | channels |
| 20 | Mempatch = Interlace | Channels are interleaved |
| 21 | | |
| 22 | [Codec] | |
| 23 | Method = Jpeg | Image coding |

In alternate embodiments, the meta-file may be set forth in the X11 parameterization format, or the eXtensible Markup Language (XML) format. The content is generally the same, but the format adheres to the selected standard. The XML format, in particular, allows other applications to easily search for and retrieve information retained in the meta-file.

For a 2-D image, the meta-file may further include, for example, the following information shown in Table 2. Note that the pixel description is based on four attributes: the rod-cone, the color-space, bits-per-channel, and number-of-channels. Presently, the various options for the pixel-descriptions are: (1) rodcone: blind, onebitblack, onebitwhite, gray, idcolor, and color and (2) colorspace: Etheral, RGB, BGR, RGBA, ABGR, CMYK, LAB, Spectral. In the case where the number of channels is greater than one, the channels may be interleaved or separated in the multi-resolution representation 120.

TABLE 2
Equivalence Table

| | | | | Number of |
|---|---|---|---|---|
| Image | Rodcone | Color Space | Bit Size | Channels |
| 1-bit, white | Etheral | OneBitBlack | 1 | 1 |
| background | | | | |
| 1-bit, black | Theral | OneBitBlack | 1 | 1 |
| background | | | | |
| Gray | Etheral | Gray | 1, 2, 4, 8, 16, . . . | 1 |
| Color Mapped | IdColor | RGB, BGR, | 1, 2, 4, 8, 16, . . . | 3 |
| | | RGBA, | | |
| | | ABGR, | | |
| | | CMYK, | | |
| | | LAB, | | |
| | | and so on | | |
| Color | Color | RGB, BGR, | 1, 2, 4, 8, 16, . . . | 3, 4 |
| | | RGBA, | | |
| | | ABGR, | | |
| | | CMYK, | | |
| | | LAB, | | |
| | | and so on | | |
| MultiSpectral | Spectral | / | 1, 2, 4, 8, 16, . . . | N |

In one embodiment, the data file includes a header and a list of data blocks referred to as image tiles or extents. At this level, the data blocks comprise a linear set of bytes. 2-D, 3-D, or other semantics are added by an application layer. The data blocks are not necessarily related to physical device blocks. Rather, their size is generally selected to optimize device access speed. The data blocks are the unit of data access and, when possible, are retrieved in a single operation or access from the disk.

The header may be in one of two formats, one format based on 32-bit file offsets and another format based on 64-bit file offsets (for file sizes larger than 2GB). The header, in one implementation, is 2048 bytes in size such that it aligns with the common secondary-storage physical block sizes (e.g., for a magnetic disk, 512 bytes, and for a CD-ROM, 2048 bytes). The two formats are presented below in Tables 3 and 4:

TABLE 3
Node data file header
32-bit file offsets

| | |
|---|---|
| Byte 0-28 | “<ExtentDataFile/LSP-DI-EPFL>\0” |
| Byte 29-42 | “Version 01.00\0” |
| Byte 43-47 | Padding (0) |
| Byte 48-51 | Endian Code |
| Byte 52-55 | Extent File Index |
| Byte 56-59 | Stripe Factor |
| Byte 60-63 | Start Extent Data Position |
| Byte 64-67 | End Extent Data Position |
| Byte 68-71 | Start Hole List Position |
| Byte 72-2047 | Padding |

TABLE 4
Node data file header
64-bit offsets

| | |
|---|---|
| Byte 0-28 | “<ExtentDataFile/LSP-DI-EPFL>\0” |
| Byte 29-42 | “Version 02.00\0” |
| Byte 43-47 | Padding (0) |
| Byte 48-51 | Endian Code |
| Byte 52-55 | Node Index |
| Byte 56-59 | Number of nodes |
| Byte 60-67 | Start Extent Data Position |
| Byte 68-75 | End Extent Data Position |
| Byte 76-83 | Start Hole List Position |
| Byte 84-2047 | Padding |

For both formats, bytes 48-51 represent the Endian code. The Endian code may be defined elsewhere as an enumerated type, for example, basBigEndian=0, basLittleEndian=1. Bytes 52-55 represent the file node index (Endian encoded as specified by bytes 48-51). Bytes 56-59 represent the number of nodes in the multi-resolution representation 120.

Start and End Extent Data Position represent the address of the first and last data bytes in the multi-resolution representation 120. The Start Hole List Position is the address of the first deleted block in the file. Deleted blocks form a linked list, with the first 4-bytes (for version 1) or 8-bytes (for version 2) in the block indicating the address of the next deleted data block (or extent). The next 4 bytes indicate the size of the deleted block. When there are no deleted blocks, the Start Hole List Position is zero.

Each data block comprises a header and a body (that contains the data block bytes). In one embodiment, the data block size is rounded to 2048 bytes to meet the physical-block size of most secondary storage devices. The semantics given to the header and the body is left open to the application developer.

The information used to access the data blocks is stored in the node address file. Typically, only the blocks that actually contain data are written to disk. The other blocks are assumed to contain (by default) NULL bytes (0). Their size is derived by the application layer of the operating system.

The address file comprises a header and a list of block addresses. One version of the header (shown in Table 5) is used for 32-bit file offsets, while a second version of the header (shown in Table 6) is used for 64-bit file offsets (for file sizes larger than 2GB). The header, in one implementation, is 2048 bytes in size to align with the most common secondary storage physical block sizes.

TABLE 5
Address data file header
32-bit offsets

| | |
|---|---|
| Byte 0-36 | “<ExtentAddressTableFile/LSP-DI-EPFL>\0” |
| Byte 37-50 | “Version 01.00\0” |
| Byte 51-55 | Padding (0) |
| Byte 56-59 | Endian Code |
| Byte 60-63 | Extent File Index |
| Byte 64-67 | Stripe Factor |
| Byte 68-71 | Extent Address Table Position |
| Byte 72-75 | Extent Address Table Size |
| Byte 76-79 | Last Extent Index Written |
| Byte 80-2047 | Padding |

TABLE 6
Address data file header
64-bit offsets

| | |
|---|---|
| Byte 0-36 | “<ExtentAddressTableFile/LSP-DI-EPFL>\0” |
| Byte 37-50 | “Version 02.00\0” |
| Byte 51-55 | Padding (0) |
| Byte 56-59 | Endian Code |
| Byte 60-63 | Extent File Index |
| Byte 64-67 | Stripe Factor |
| Byte 68-71 | Extent Address Table Position |
| Byte 72-75 | Extent Address Table Size |
| Byte 76-79 | Last Extent Index Written |
| Byte 80-2047 | Padding |

For both formats, bytes 56-59 represent the Endian code. The Endian code may be defined elsewhere as an enumerated type, for example, basBigEndian=0, basLittleEndian=1. Bytes 60-63 represent the file node index (Endian encoded as specified by bytes 48-51). Bytes 64-67 represent the number of nodes in the multi-resolution representation 120. Bytes 68-71 represent the offset in the file of the block address table. Bytes 72-75 represent the total block address table size. Bytes 76-69 represent the last block address actually written.

Preferrably, the block addresses are read and written from disk (e.g., secondary storage 108) in 32 KByte chunks representing 1024 block addresses (version 1) and 512 block addresses (version 2).

A block address comprises the following information shown in Tables 7 and 8:

TABLE 7
Block address information (version 1)

| | |
|---|---|
| Bytes 0-3 | Block header position |
| Bytes 4-7 | Block header size |
| Bytes 8-11 | Block body size |
| Bytes 12-15 | Block original size |

TABLE 8
Block address information (version 2)

| | |
|---|---|
| Bytes 0-7 | Block header position |
| Bytes 8-11 | Block header size |
| Bytes 12-15 | Block body size |
| Bytes 16-19 | Block original size |
| Bytes 20-31 | Padding |

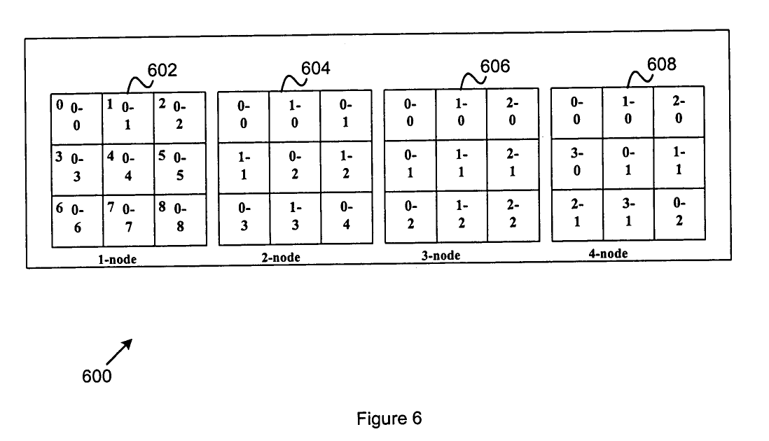

Turning to FIG. 5, that figure shows an example 500 of a multi-resolution representation 120 according to this invention in which five blocks have been written in the following order: 1) The block with index 0 (located in the address file at offset 2048) has been written in the data file at address 2048. Its size is 4096 bytes. 2) The block with index 10 (located in the address file at offset 2368) has been written in the data file at address 6144. Its size is 10240 bytes. 3) The block with index 5 (located in the address file at offset 2208) has been written in the data file at address 16384. Its size is 8192 bytes. 4) The block with index 2 (located in the address file at offset 2112) has been written in the data file at address 24576. Its size is 2048 bytes. 5) The block with index 1022 (located in the address file at offset 34752) has been written in the data file at address 26624. Its size is 4096 bytes

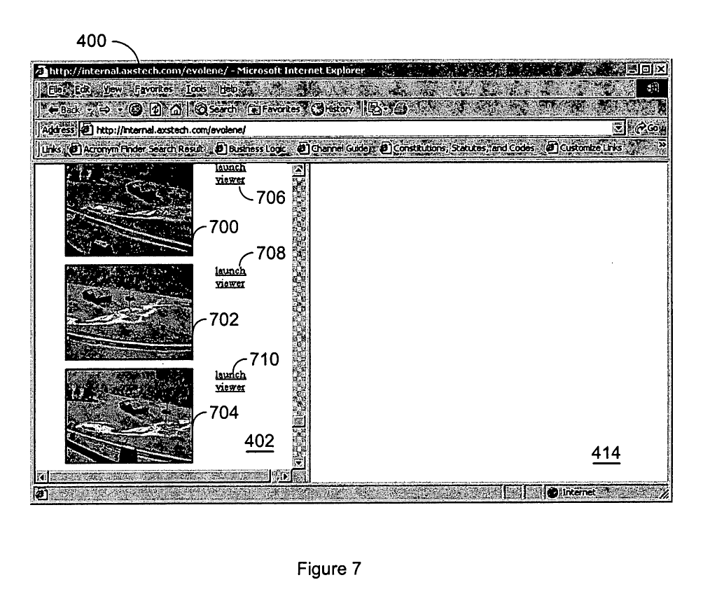

With regard to FIG. 6, that figure shows an example of a node/block index allocation for a 1, 2, 3, 4-node file comprising 3×3 image tiles. Assuming that the 2-D tiles are numbered line-by-line in the sequence shown in the upper left hand corner of the leftmost 3×3 set of image tiles 602, then: 1) in the case of a 1-node multi-resolution representation 120, all tiles are allocated to node 0, and block indices equal the tile indices, as shown in the leftmost diagram 602; 2) in the case of a 2-node multi-resolution representation 120, tiles are allocated in round-robin fashion to each node, producing the indexing scheme presented in the second diagram 604 from the left; 3) in the case of a 3-node multi-resolution representation 120, tiles are allocated in round-robin fashion to each node, producing the indexing scheme presented in the second diagram 606 from the right; 4) in the case of a 4-node multi-resolution representation 120, tiles are allocated in round-robin fashion to each node, producing the indexing scheme presented in the rightmost diagram 608.

The general formula for deriving node- and block- indices from tile indices is:

NodeIndex=TileIndex mod NumberOfNodes, BlockIndex=TileIndex div NumberOfNodes.

Referring again to FIG. 3, the distribution may be performed as described in U.S. Pat. No. 5,737,549. Furthermore, the image tiles (or identified original image 60 in base format) may be color coded according to a selected color coding format either before or after the resolution representation 120 is generated or before or after the multi-resolution representation 120 is distributed across multiple disks. (Step 316). As noted above, the multi-resolution representation 120 may be distributed across multiple disks to enhance access speed. (Step 318).

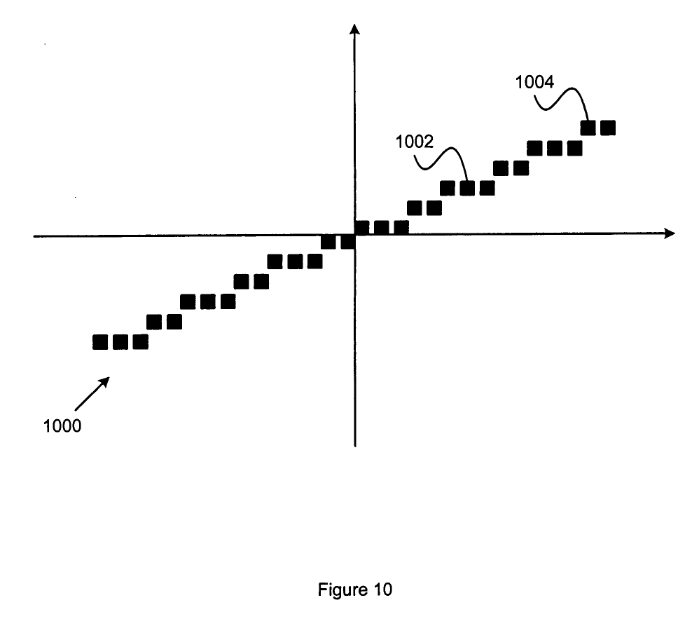

Next, the image sharing server 140 generates an output image based on the starting resolution indicated by the image control parameters. (Step 320). In one implementation the image sharing server 140 produces the output image by invoking the image generation tool to perform the process shown in FIG. 9. Alternatively, if the control image parameters are predefined so that the starting resolution of the output image corresponds to one of the image entries (122, 124, or 126), then the image sharing server may provide the output image by accessing the multi-resolution image 120 without invoking the image generation tool 116.

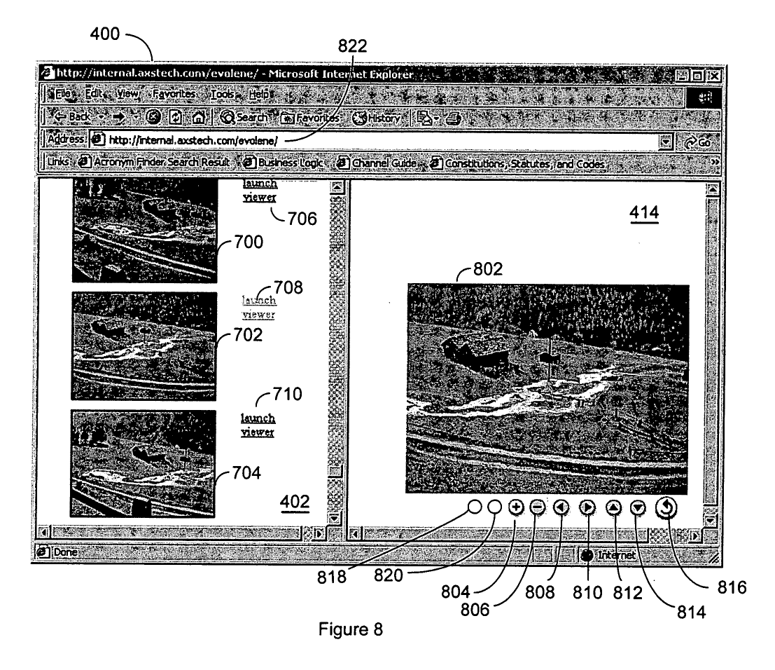

After generating the output image, the image sharing server 140 may display the output image. (Step 322). In the implementation shown in FIG. 7, the image sharing server 140 displays the output image 700, 702, and 704 on panel 402 after receiving the output control parameters for the starting resolution of the output image and the identification of the respective original image (e.g., 406, 408, and 410). Thus, a person using the display 110 of the image processing system 100 may view the output image 700, 702, or 704 before the output image is shared with another person using client computer 52.

Next, the image server 140 may provide a selection for the displayed output image. (Step 324). In the implementation shown in FIG. 7, the image addressing server (via web browser 136 on image processing system 100) may display output image 700, 702, and 704 such that the output image 700, 702, and 704 is selectable by a person accessing web page 144 from client computer 52. In another implementation, the image addressing server 140 may provide a separate selection mechanism 706, 708, and 710, such as the depicted hyperlink. Thus, the image sharing server may associate multiple output images 700, 702, and 704 with the web page 144 and provide a corresponding selection 706, 708, and 710 for each output image 700, 702, and 704 so that a person accessing the web page 144 from the client computer 144 may identify one of the output images 700, 702, and 704 for further processing, such as expanding the view or saving the selected output image. In addition, the person seeking to share the output images 700, 702, and 704 that correspond to a respective original image 60 is able to view the output images 700, 702, and 704 as they would appear to the person accessing the web page 144 on client computer 52.

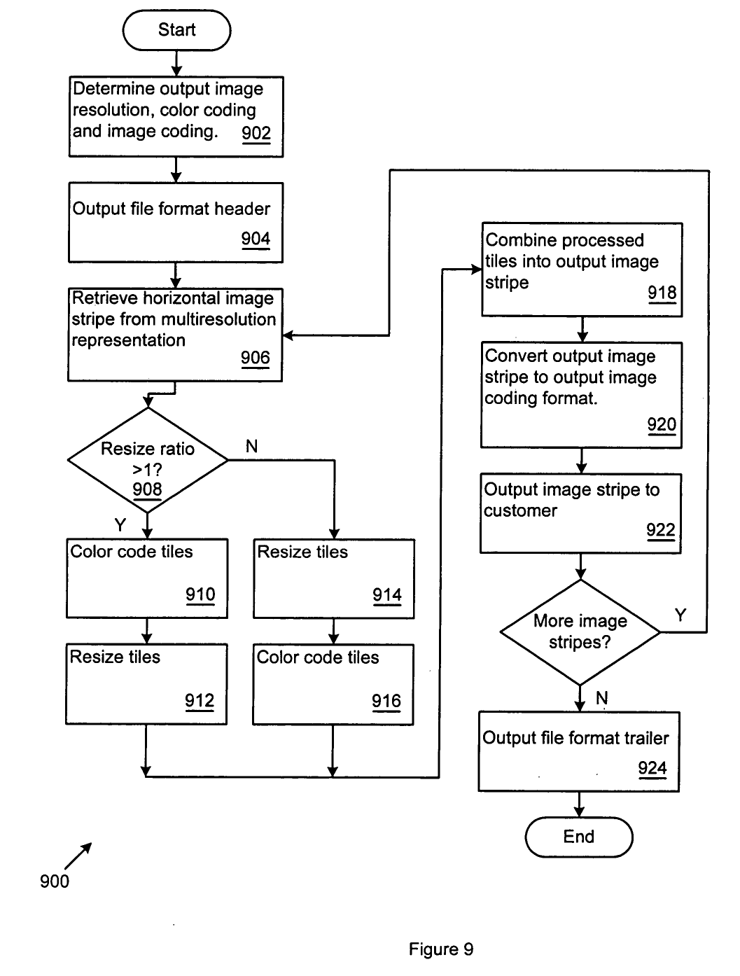

In the implementation shown in FIG. 8, when either the output image (e.g., 702) or the separate selection 708 is selected, the image addressing server 140 provides another output image 802 based on the expanded view size that the image addressing server received as an image control parameter to associate with the web page 144. In one implementation the image sharing server 140 produces the other output image by invoking the image generation tool to perform the process shown in FIG. 9 using the expanded view size. Alternatively, if the control image parameters are predefined so that the expanded view size of the output image corresponds to one of the image entries (122, 124, or 126), then the image sharing server may provide the other output image by accessing the multi-resolution image 120 without invoking the image generation tool 116.

The image sharing server may also provide a resize option to alter the view of the selected output image (Step 326). In the implementation shown in FIG. 8, the image sharing server provides resize options 804, 806, 808, 810, 812, 814, and 816 to allow a person that has accessed the web page 144 to request that the selected output image 802 be resized in accordance with the requested resize option 804, 806, 808, 810, 812, 814 and 816. For example, resize option 804 may request the image sharing server 140 to “zoom in” to expand a portion of image 802 or to provide digital content of the original image 60 in greater resolution based on the multi-representation representation 120. Resize option 806 may request the image sharing server “zoom out” to expand the entire view of the selected output image 802 by providing another output image having more digital content of the original image 60 based on a lower resolution from the multi-resolution representation 120. Resize options 808, 810, 812, and 814 may request the image sharing server 140 to respectively “pan” left, right, up, or down in reference to the displayed output image 802. In response to a “pan” resize option, the image sharing server 140 provides another output image having different digital content of the original image 60 (e.g., adjacent pixels or tiles 128 of a another image entry 124 or 126 having a greater resolution than the image entry used to generate the output image 118) in accordance with the requested “pan” resize option 808, 810, 812, and 814. Resize option 816 may request the image sharing server 140 to reset the selected output image 802 to the size and resolution of the output image before any of the resize options were processed by the image sharing server 140. In one implementation, the image sharing server invokes the resampling tool to process the resize options 804, 806, 808, 810, 812, and 816 as further discussed below.

Next, the image sharing server 140 may provide a save option 818 to save the displayed output image on the client computer 52. (Step 328). To save the displayed output image the image sharing server 140 may invoke the operating system of the client computer 52 using known file management calls or application program interface commands to save the displayed output image on the client computer 52. The image sharing server 140 may cause the displayed output image to be stored in the base format associated with the multi-resolution representation of the original image 60. Alternatively, the image sharing server 140 may convert the displayed output image to another known format, such as *.tiff or *.jpeg before saving the displayed output image. Accordingly, the image sharing server 140 allows the person using the client computer 52 to alter the view of the displayed output image 802 and then save the altered display output image 802 on the client computer 52 without having to download the high resolution original image 60 (e.g.. 2024×2024 pixels or larger).

However, the image sharing server 140 may also provide a download option 820 to save the original image on the client computer 54. (Step 330). Thus, the image sharing server 140 allows the person using the client computer 52 to view the displayed output image 802 before choosing to download the high resolution original image 60 (e.g.. 2024×2024 pixels or larger), which may take a significant amount of time depending on the bandwidth of the network 54 between the image processing system 100 and the client computer 52.

The image sharing server 140 then generates a network address for the web page 144. (Step 332). For example, the image sharing server 140 may generate the URL 822 of the web page 144 shown in FIG. 8. The image sharing server 140 then stores the image control parameters and network address (e.g. 822) of the web page 140 in association with the web page (Step 334).

Turning to FIG. 9, that figure depicts a flow diagram 900 illustrating an exemplary process performed by the image generation tool 116 when invoked by the image showing server 140 to produce the output image 118 to share with the client computer 52 across the network 54. The image generation tool 116 first determines output parameters including an output image resolution, size, an output color coding format, and an output image coding format (Step 902). As an example, the image generation tool 116 may determine the output parameters based on a request received at the image processing system 100 from the client computer 52. For instance, the image generation tool 116 may receive (via the image sharing server 140) a message that requests that a version of an original image 60 be delivered to the client computer 52 at a specified resolution, color coding format, and image coding format. In one implementation, the image generation tool 116 receives the specified resolution, color coding format, and image coding format as image control parameters (e.g., starting resolution of the output image 118) from the image sharing server 140.

Optionally, the image generation tool 116 may determine or adjust the output parameters based on a customer connection bandwidth associated with a communication channel from the image processing system 100 to the customer (e.g., the connection bandwidth of network 54 between image processing system 100 and client computer 52.). Thus, for example, when the communication channel is a high speed Ethernet connection, then the image generation tool 116 may deliver the output image at the full specified resolution, color coding, and image coding. On the other hand, when the communication channel is a slower connection (e.g., a serial connection) then the image generation tool 116 may reduce the output resolution, or change the color coding or image coding to a format that results in a smaller output image. For example, the resolution may be decreased, and the image coding may be changed from a non-compressed format (e.g., bitmap) to a compressed format (e.g., jpeg), or from a compressed format with a first compression ratio to the same compressed format with a greater compression ratio (e.g., by increasing the jpeg compression parameter), so that the resultant output image has a size that allows it to be transmitted to the client computer 52 in less than a preselected time.

Referring again to FIG. 9, once the output parameters are determined, the image generation tool 116 outputs a header (if any) for the selected image coding format. (Step 904). For example, the image generation tool 116 may output the header information for the jpeg file format, given the output parameters. Next, the image generation tool 116 generates the output image 118.

The image generation tool 116 dynamically generates the output image 118 starting with a selected image entry in the multi-resolution representation 120 of the original image. To that end, the image generation tool 116 selects an image entry based on the desired output image resolution (e.g., starting resolution of the image control parameters specified by the image sharing server 140). For example, when the multi-resolution representation 120 includes an image entry at exactly the desired output resolution, the image generation tool 116 typically selects that image entry to process to dynamically generate the output image 118 to share with the client computer 52 as further described below. In many instances, however, the multi-resolution representation 120 will not include an image entry at exactly the output resolution.

As a result, the image generation tool 116 will instead select an image entry that is near in resolution to the desired output image resolution. For example, the image generation tool 116 may, if output image quality is critical, select an image entry having a starting resolution that is greater in resolution (either in x-dimension, y-dimension, or both) than the desired output image resolution. Alternatively, the image generation tool 116 may, if faster processing is desired, select an image entry having a starting resolution that is smaller in resolution (either in x-dimension, y-dimension, or both) than the output resolution.

If the selected image entry does not have the desired output image resolution, then the image generation tool 116 applies a resizing technique on the image data in the selected image entry so that the output image will have the desired output image resolution. The resize ratio is the ratio of the output image size to the starting image size (i.e., the size of the selected image entry). The resize ratio is greater than one when then selected version will be enlarged, and less than one when the selected version will be reduced. Note that generally, the selected image entry in the multi-resolution representation 120 is not itself changed. However, the resizing is applied to image data in the selected image entry.

The resizing operation may be implemented in many ways. For example, the resizing operation may be a bi-linear interpolation resampling, or pixel duplication or elimination. In one embodiment, the image generation tool 116 invokes the resampling tool 132 to resample the image tiles as discussed below. In this implementation, the image generation tool 116 may identify the selected image entry (e.g., 122, 124, or 126) to the resampling tool 132 to perform the resizing operation.

In carrying out the resizing operation, the image generation tool 116 retrieves an image stripe from the selected image entry. (Step 906). As noted above, the image stripe is composed of image tiles that horizontally span the image entry.

If the resize ratio is greater than one (Step 908), then the image generation tool 116 color codes the image tiles in the image stripe to meet the output color coding format. (Step 910). Subsequently, the image generation tool 116 resizes the image tiles to the selected output resolution. (Step 912).

Alternatively, if the resize ratio is less than one, then the image generation tool 116 20 first resizes the image tiles to the selected output resolution. (Step 914). Subsequently, the image generation tool 116 color codes the image tiles to meet the output color coding format. (Step 916).

The image tiles, after color coding and resizing, are combined into an output image stripe. (Step 918). The output image stripes are then converted to the output image coding format (Step 920). For example, the output image stripes may be converted from bitmap format to jpeg format. While the image generation tool 116 may include the code necessary to accomplish the output image coding, the image generation tool 116 may instead execute a function call to a supporting plug-in module. Thus, by adding plug-in modules, the image coding capabilities of the image generation tool 116 may be extended.

Subsequently, the converted output image stripes may be transmitted to the customer (e.g., client computer 52) using methods and systems consistent with the present invention as further described below. (Step 922). After the last output image stripe has been transmitted, the image generation tool 116 outputs the file format trailer (if any). (Step 924). Note that image generation tool 116, in accordance with certain image coding formats (for example, tiff) may instead output a header at Step 904.

The multi-resolution representation 120 stores the image entries in a preselected image coding format and color coding format. Thus, when the output parameters specify the same color coding, image coding, size, or resolution as the image entry, the image generation tool 116 need not execute the color coding, image coding, or resizing steps described above.

The steps 906-922 may occur in parallel across multiple CPUs, multiple image processing systems 100, 148-154, and multiple instances of the image generation tool 116. Furthermore, the image generation tool 116 typically issues a command to load the next image stripe while processing is occurring on the image tiles in a previous image stripe as would be understood by those in the art having the present specification before them. The command may be software code, specialized hardware, or a combination of both.

Note that a plug-in library may also be provided in the image processing system 100 to convert an image entry back into the original image. To that end, the image processing system 100 generally proceeds as shown in FIG. 9, except that the starting image is generally the highest resolution image entry stored in the multi-resolution representation 120.

Note also that as each customer request from client computer 52 for an output image is fulfilled, the image generation tool 116 may store the output image in a cache or other memory. The cache, for example, may be indexed by a “resize string” formed from an identification of the original image 60 and the output parameters for resolution, color coding and image coding. Thus, prior to generating an output image from scratch, the image generation tool 116 may instead search the cache to determine if the requested output image has already been generated. If so, the image generation tool 116 retrieves the output image from the cache and sends it to the client computer 52 instead of re-generating the output image.

Color coding is generally, though not necessarily, performed on the smallest set of image data in order to minimize computation time for obtaining the requested color coding. As a result, when the resampling ratio is greater than one, color coding is performed before resizing. However, when the resampling ratio is less than one, the resizing is performed before color coding.

Tables 9 and 10 show a high level presentation of the image generation steps performed by the image generation tool 116.

TABLE 9
For a resize ratio that is greater than one

```
Output file format header
For each horizontal image stripe
  In parallel for each tile in the image stripe
    color code tile
    resize color coded tile
    assemble resampled color coded tile into image stripe
  output horizontal image stripe
output file format trailer
```

TABLE 10
For a resize ratio that is less than one

```
Output file format header
For each horizontal image stripe
  In parallel for each tile in the image stripe
    resize tile
    color code resized tile
    assemble resampled color coded tile into image stripe
  output horizontal image stripe
output file format trailer
```

The image generation technique described above has numerous advantages. A single multi-resolution representation 120 may be used by the image sharing server 140 and the image generation tool 116 to dynamically generate different output image sizes, resolutions, color coding and image coding formats for multiple client computers 52 across the network 54. Thus, only one file need be managed by the image sharing server 140 or the image generation tool 116, with each desired image dynamically generated upon client request from the multi-resolution representation 120 using methods and systems consistent with the present invention.

The image generation tool 116 also provides a self-contained “kernel” that can be called through an Application Programming Interface. As a result, the image sharing server 140 can call the kernel with a selected output image size, resolution, color coding and image coding format. Because the color coding format can be specified, the image generation tool 116 can dynamically generate images in the appropriate format for many types of output devices that have web-enabled capabilities, ranging from black and white images for a handheld or palm device to full color RGB images for a display or web browser output. Image coding plug-in modules allow the image generation tool 116 to grow to support a wide range of image coding formats presently available and even those created in the future.

C. Resampling Tool

As previously discussed, the resampling tool 132 is operably coupled to the image generation tool 116 and, thus, to the image sharing server 140 to perform a resizing operation on a selected source image, such as the image entry 122, 124, or 126, or horizontal image stripe thereof, identified by the image generation tool 116 in step 910 of FIG. 9. In general, the resampling tool 132 resamples the selected source image tiles (e.g., tiles 128 of the image entry 122, 124, or horizontal image stripe thereof in FIG. 1) to form a target image (e.g., output image 118) from resampled tiles 119. As described above, the target or output image 118 may be further processed by the image generation tool 116 before the output image 118 is provided to the client computer 52 in accordance with methods and systems consistent with the present invention.

The resampling tool 132 performs a resizing operation to reflect a resize option 804 (e.g., “zoom in”), 806 (e.g., “zoom out”), 808 (e.g., “pan left”), 810 (e.g., “pan right”), 812 (e.g., “pan up”), 814 (e.g., “pan down”), and 816 (e.g., “reset”) as requested from the client computer 52 upon access to web page 144.

A resampling operation is based on the relationship that exists between image size and image resolution, and the number of pixels in an image. In particular, a source image (e.g., image entry 122, 124, or 126) has a width (e.g., Xsize) and a height (e.g., Ysize) measured in pixels (given, for example, by the parameters pixel-width and pixel-height). An image is output (e.g., printed or displayed) at a requested width and height measured in inches or another unit of distance (given, for example, by the parameters physical-width and physical-height). The output device is characterized by an output resolution typically given in dots or pixels per inch (given, for example, by the parameters horizontal-resolution and vertical-resolution). Thus, pixel-width=physical-width * horizontal-resolution and pixel-height=physical-height * vertical-resolution. The image generation tool 116 may dynamically generate an output image, such as output image 118, to match any specified physical-width and physical-height by invoking the resampling tool 132 to resample a source image (e.g., image entry 122, 124, or 126) to increase the number of pixels horizontally or vertically.

The tiles of the source image (e.g., tiles 128 of the image entries 122, 124, and 126) are Xsize pixels wide, and Ysize pixels long. The number of source tiles 128 may vary considerably between source images. For example, Xsize and Ysize may both be 10 pixels or more in order to form source tiles 128 with more than 100 pixels.

The resampling tool 132 determines for each resampled tile 119 a number, h, of resampled pixels in a horizontal direction and a number, v, of resampled pixels in a vertical direction necessary to appropriately fill the resampled portion of the image previously represented by tile 119. As will be explained in greater detail below, the resampling tool 132 determines the numbers h and v of resampled pixels, and chooses their positions by uniformly distributing the resampled pixels, such that a resampled pixel depends only on source pixels in the source tile in which any given resample pixel is positioned.

In making the determination of the numbers h and v, the resampling tool 132 determines plateau lengths of a discrete line approximation D(a, b). The parameter ‘a’ is less than the parameter ‘b’, and ‘a’ and ‘b’ are mutually prime. To draw the D(a, b) discrete line, a line counter is initialized at zero, and a unit square pixel with bottom-left corner is placed at the origin (0,0). Next, the following steps are repeated: (1) The parameter ‘a’ is added to the line counter, and 1 is added to the pixel X-coordinate; (2) If the line counter is larger than the parameter ‘b’, then the line counter is replaced by the result of the calculation (line counter mod b) and 1 is added to the pixel Y-coordinate; and (3) a pixel is added at the new X-coordinate and Y-coordinate. Table 11 shows the value of the line counter and pixel-coordinates for several steps in the D(2,5) discrete line.

TABLE 11

| line counter | 0 | 2 | 4 | 1 | 3 | 0 | 2 | 4 | 1 |
|---|---|---|---|---|---|---|---|---|---|
| pixel-coordinate | (0, 0) | (1, 0) | (2, 0) | (3, 1) | (4, 1) | (5, 2) | (6, 2) | (7, 2) | (8, 3) |

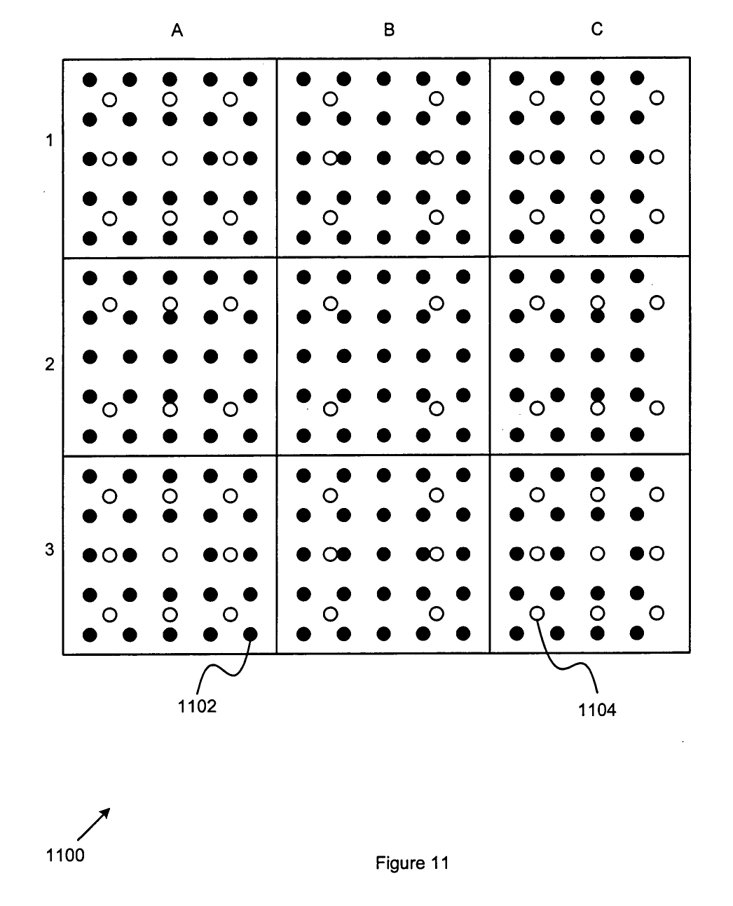

FIG. 10 shows a portion of the D(2,5) discrete line 1000. The discrete line 1000 includes plateaus, two of which are designated 1002 and 1004. A plateau is a set of contiguous pixels where the Y-coordinate does not change. The first plateau has a length of three pixels, and the second plateau has a length of two pixels. In general, under the assumptions given above, a discrete line D(a, b) will have plateau lengths (a div b) or (a div b)+1.

Note that the resampling tool 132 will create the target image 118 based on a preselected resampling ratio (alpha/beta), with alpha and beta mutually prime. The resampling ratio is the fractional size of the target image 118 compared to the source image 118. For example, resampling a 1000×1000 pixel image to a 600×600 pixel image corresponds to a resampling ratio of 600/1000=3/5. The resampling ratio may be identified to the resampling tool 132 by the image generation tool 116.

The resampling tool 132 determines the number, h, of resampled pixels in the horizontal direction in accordance with the plateau lengths of the discrete line approximation D(beta, alpha * Xsize). Similarly, the number, v, of resampled pixels in the vertical direction is given by the plateau lengths of the discrete line approximation D(beta, alpha * Ysize). Each new plateau gives the number of pixels h or v in the next resampled tile 119. Because the plateau lengths vary, so do the number of pixels, h and v, between resampled tiles 119.

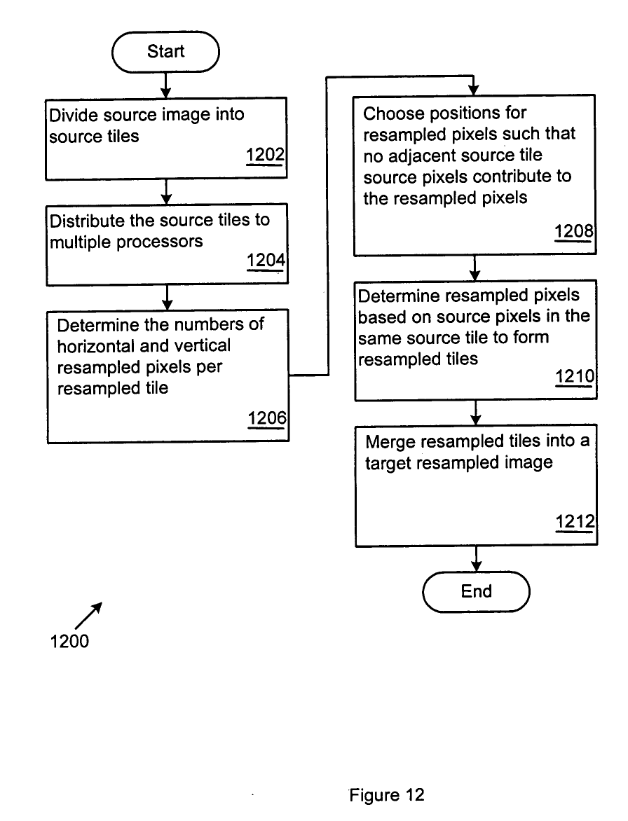

For example, FIG. 11 illustrates a section 1100 of an example source image broken into source tiles A1-C3. Solid black circles indicate source pixels 1102 in the example image. Open circles represent resampled pixels 1104 based on the source pixels 1102. For the source tiles 1102, Xsize=5 and Ysize=5. The resampling ratio is (1/2) (i.e., for every 10 source pixels, there are 5 resampled pixels).

Since Xsize=Ysize=5, the number v=the number h=the plateau lengths of the discrete line D(2, 1 * 5)=D(2, 5). As shown above, the discrete line D(2, 5) yields plateau lengths that vary between 3 pixels and 2 pixels. As a result, moving horizontally from tile to tile changes the number of horizontal resampled pixels, h, from 3 to 2 to 3, and so on. Similarly, moving vertically from tile to tile changes the number of vertical resampled pixels, v, from 3 to 2 to 3, and so on. Thus, the number, h, for the tiles A1, A2, A3, C1, C2, and C3 is 3 and the number, h, for the tiles B1, B2, and B3 is 2. The number, v, for the tiles A1, B1, C1, A3, B3, and C3 is 3 and the number, v, for the tiles A2, B2, and C2 is 2.

In a given source tile (e.g., A1), the resampling tool 132 chooses positions for the resampled pixels 1104 relative to the source pixels 1102 such that no source pixels in adjacent source tiles (e.g., B1 or A2) contribute to the resampled pixels. The process may be conceptualized by dividing the source tile into v horizontal segments and h vertical segments. The horizontal segment and vertical segments intersect to form a grid of h*v cells. A resampled pixel is placed at the center of each cell.

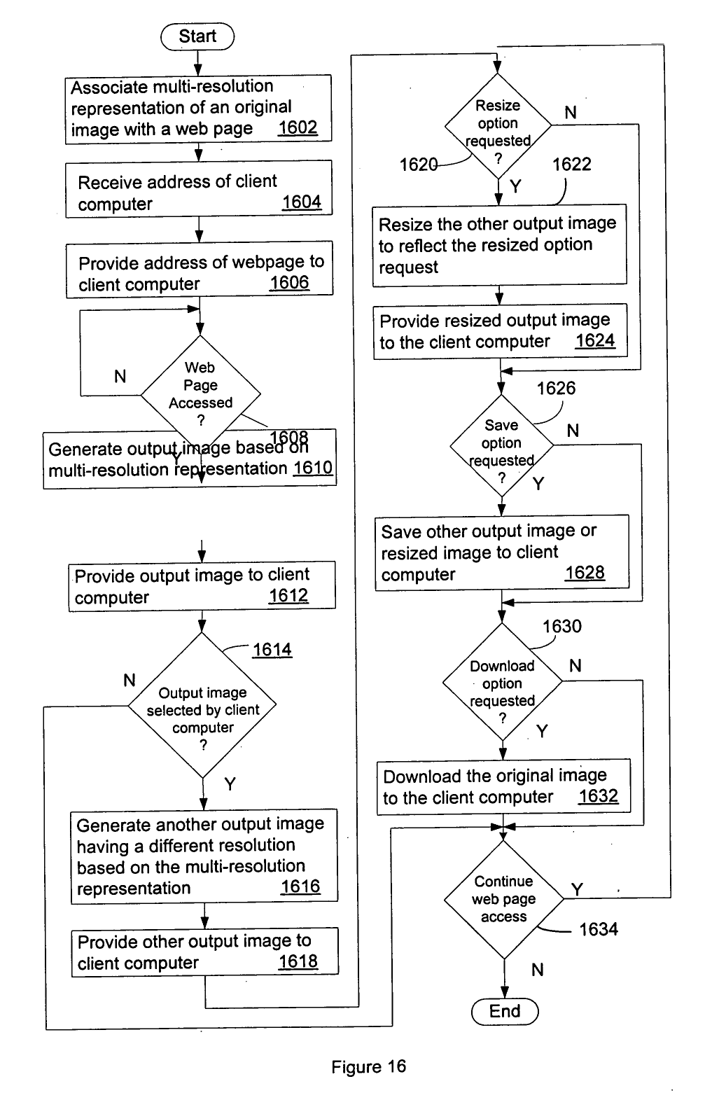

Turning briefly to FIG. 15, for example, the figure provides an expanded view 1500 of the source tile B1 of FIG. 11. Again, solid black circles indicate source pixels while open circles represent resampled pixels based on the source pixels. The solid black circles represent a 5×5 source tile, while the open circles represent a 2×3 resampled tile.

The source pixels for B1 (shown in FIG. 15) are centered at the grid coordinates shown below in Table 12:

TABLE 12

| | | | | |
|---|---|---|---|---|
| (2.5, 2.5) | (7.5, 2.5) | (12.5, 2.5) | (17.5, 2.5) | (22.5, 2.5) |
| (2.5, 7.5) | (7.5, 7.5) | (12.5, 7.5) | (17.5, 7.5) | (22.5, 7.5) |
| (2.5, 12.5) | (7.5, 12.5) | (12.5, 12.5) | (17.5, 12.5) | (22.5, 12.5) |
| (2.5, 17.5) | (7.5, 17.5) | (12.5, 17.5) | (17.5, 17.5) | (22.5, 17.5) |
| (2.5, 22.5) | (7.5, 22.5) | (12.5, 22.5) | (17.5, 22.5) | (22.5, 22.5) |

The resampled pixels for B1 (shown in FIG. 15) are centered at the coordinates shown below in Table 13:

TABLE 13

| | |
|---|---|
| (6.25, 4.1666) | (18,75, 4.1666) |
| (6.25, 12.5) | (18.75, 12.5) |
| (6.25, 18.833) | (18.75, 18.833) |

Because the number h=2, the source tile B1 is conceptually divided into two vertical segments 1502 and 1504. Because the number v=3, the source tile B I is conceptually divided into three horizontal segments 1506, 1508, and 1510. Resampled pixels are placed centrally with regard to each horizontal segment 1506-1510 and each vertical segment 1502-1504 (i.e., in the center of each of the six cells formed by the horizontal and vertical segments 1502-1510).

For the resampled pixel r_{B1}, for example, the parameters ‘a’ and ‘b’ are ((6.25−2.5)/5, (4.166−2.5)/5)=(0.75, 0.333). For the resampled pixel rB2, the parameters ‘a’ and ‘b’ are (0.75,0).

Next, the resampling tool 132 determines each resampled pixel 1104 based on the source pixels 1102 that contribute to that resampled pixel. Due to the distribution of resampled pixels 1104 explained above, only source pixels in the same source tile as the resampled pixel 1104 need to be considered. In one embodiment, the resampling tool 132 determines a value, r, for each resampled pixel, in one embodiment according to:

r=(1−a)(1−b)sₜₗ+(a)(1−b)sₜᵣ+(1−a)(b)s_{b1}+(a)(b)s_{b},

where Sₜₗ, Sₜₗ, S_{bl}, and S_{br} are the values of the closest top-left, top-right, bottom-left, and bottom-right neighbors of the resampled pixel in the source tile, and ‘a’ and ‘b’ are the relative horizontal and vertical positions of the resampled pixel with respect to the neighbors.

If a resampled pixel is aligned vertically with the source pixels, the four neighboring pixels are considered to be the two aligned source pixels and their two right neighbors. If the resampled pixel is aligned horizontally with the source pixels, the four neighboring pixels are considered to be the two aligned source pixels and their two bottom neighbors. Finally, if a resampled pixel is aligned exactly with a source pixel, the four neighboring pixels are considered with respect to the aligned pixel, its right neighbor, its bottom neighbors and its bottom-right neighbor.

Note that choosing the number and positions for the resampled pixels as described above eliminates the need to retrieve adjacent source tiles to arrive at a value for a resampled pixel. In other words, the resampled pixel does not depend on source pixels in adjacent source tiles. In this manner, image resampling is accelerated by avoiding data transfer delays and synchronization overhead.

The resampled pixels form resampled tiles. Once the resampled tiles are determined, the resampling tool 132 forms the complete resampled image (e.g., output image 118) by merging the resampled tiles. As noted above, one or more independent processors or image processing systems may be involved in determining the full set of resampled tiles that make up a resampled image.

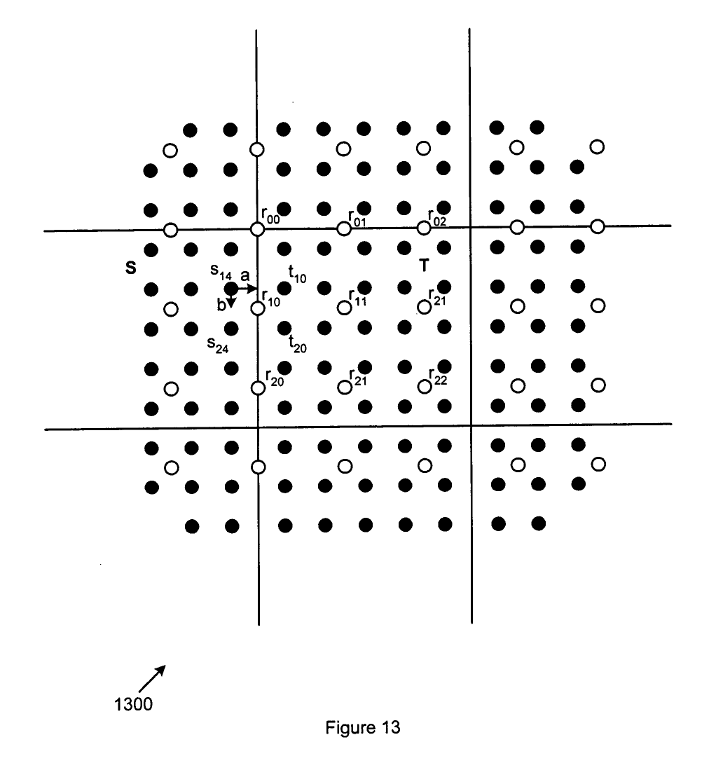

Turning next to FIG. 12, that figure shows a flow diagram the processing steps performed in resampling a source image. Initially, a source image is partitioned into multiple source tiles of any preselected size. (Step 1202). The source tiles may then be distributed to multiple processors. (Step 1204). Steps 1202 and 1204 need not be performed by the resampling tool 132. Rather, an operating system or an application program, such as the image sharing server, may divide the source image and distribute it to the processors as described above for generating the multi-resolution representation 120.

After the source image is partitioned into multiple source tiles and the source tiles are distributed (if at all) to multiple processors, the resampling tool 132 determines the number, h, and number v, of horizontal and vertical resampled pixels per resampled tile. (Step 1206). To that end, the resampling tool 132 may use the plateau lengths of the discrete line approximation D(a,b) as noted above. Having determined the numbers h and v, the resampling tool 132 chooses positions for the resampled pixels. (Step 1208). The positions are selected such that a given resampled pixel does not depend on source pixels in any adjacent source tiles.

Once the positions for the resampled pixels are established, the resampling tool 132 determines the resampled pixels. (Step 1210). As noted above, because the resampled pixels do not depend on source pixels in adjacent tiles, the resampling tool need not spend time or resources transferring source tile data between processors, synchronizing reception of the source tiles, and the like. The resampled pixels form resampled tiles.

Once the resampled tiles are available, the resampling tool 132 (or another application such as the image generation tool 116) merges the resampled tiles into a resampled image. (Step 1612). For example, the resampled pixels in each resampled tile may be copied in the proper order into a single file that stores the resampled image for further processing by the image generation tool 116.

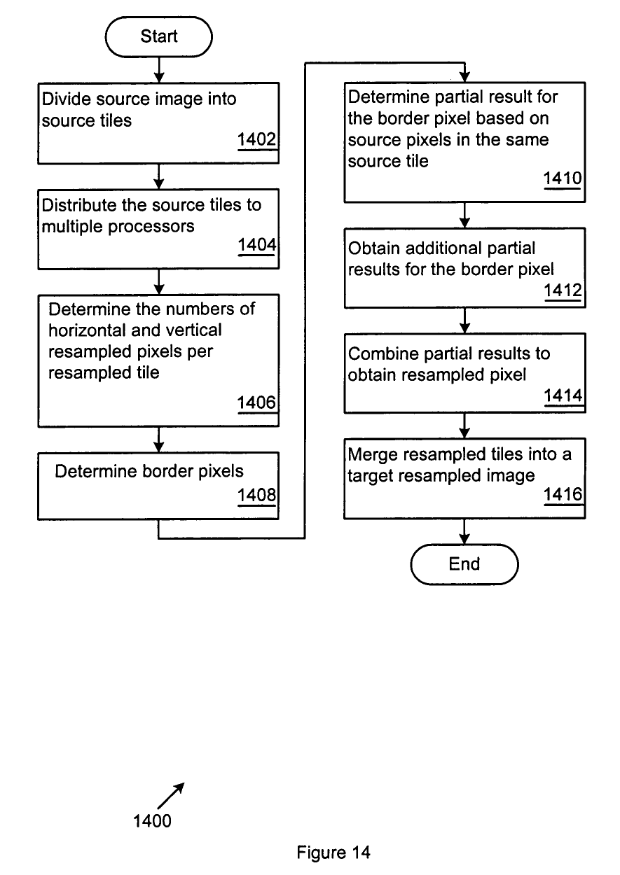

In an alternate embodiment, the resampling tool 132 determines resampled pixels as shown in FIG. 13. FIG. 13 illustrates a source tile S and a source tile T, source pixels S14 and S24 in the source tile S, and source pixels t₁₀ and t₂₀ in the source tile T. Also shown are resampled pixels r₀₀, r₀₁, r₀₂, r₁₀, r₁₁, r₁₂, r₂₀, r₂₁, and r₂₂.

Note that no special processing has been performed to position the resampled pixels such they depend only on source pixels in a single source tile. As a result, some resampled pixels (in this example, r₀₀, r₀₁, r₀₂, r₁₀, and r₂₀) are border pixels. In other words, resampled pixels r₀₀, r₀₁, r₀₂, r₁₀, and r₂₀ depend on source pixels in adjacent source tiles. As one specific example, the resampled pixel r₁₀ depends on source pixels in the source tile S (namely S₁₄ and S₂₄) and source pixels in the source tile T (namely t₁₀ and t₂₀).

The resampling tool 132, rather than incurring the inefficiencies associated with requesting and receiving adjacent source tiles from other processors or image processing systems, instead computes partial results (for example, partial bi-linear interpolation results) for each border pixel. With regard to the resampled pixel r₁₀, for example, the resampling tool 132 running on the source tile T processor determines a first partial result according to:

r^{T}₁₀=(a)(1−b)t₁₀+(a)(b)t₂₀

The first partial result gives the contribution to the resampled pixel r₁₀ from the source tile T. Similarly, the source tile S processor computes a second partial result for the resampled pixel r₁₀ according to:

r^{S}₁₀=(1−a)(1−b)S₁₄+(1−a)(b)s₂₄

The resampling tool 132 running on the source tile T processor may then request and obtain the second partial result from the source tile S processor, and combine the partial results to obtain the resampled pixel. Alternatively, the partial results may be separately stored until an application (as examples, an image editor operably coupled to the image sharing server 140, image generation tool 116, or the resampling tool 132 itself) merges the resampled tiles to form the resampled image.

Under either approach, the application obtains the data for the resampled pixels, whether completely determined, or partially determined by each processor or image processing system. With respect to r₁₀, for example, the application combines the first partial result and the second partial result to obtain the resampled pixel. Specifically, the application may add the first partial result to the second partial result.

Note that under the approach described above with respect to FIG. 13, the resampling tool 132 avoids the overhead that arises from requesting and receiving adjacent source tiles from other processors or image processing systems. Instead, partial results are determined and stored until needed.

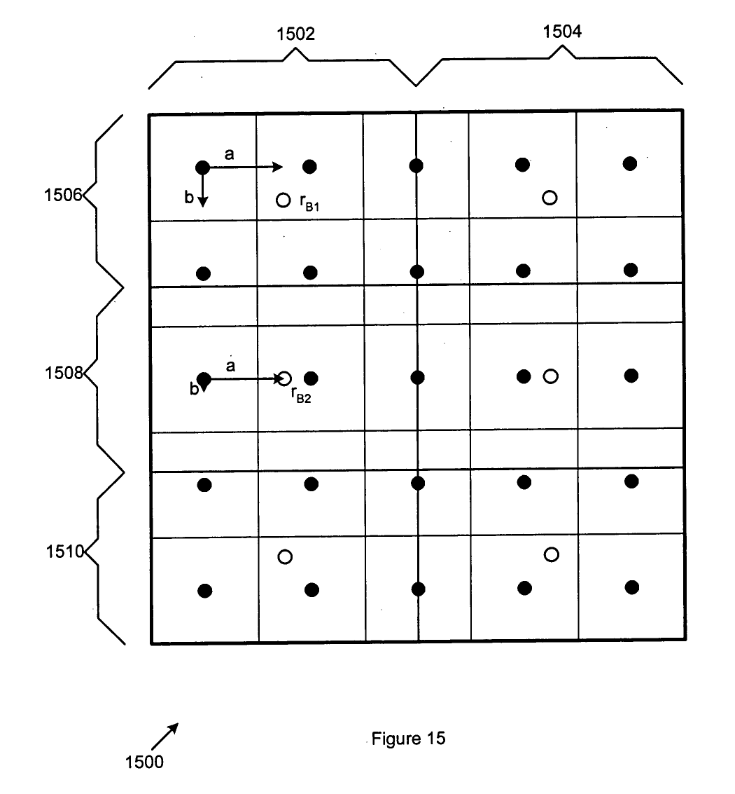

Turning next to FIG. 14, that figure shows a flow diagram 1400 of the processing steps performed in resampling a source image according to this second approach. Initially, a source image is partitioned into multiple source tiles of any preselected size. (Step 1402). The source tiles may be distributed to multiple processors. (Step 1404). Steps 1402 and 1404 need not be performed by the resampling tool 132. Rather, an operating system itself, or another application program, such as the image generation tool 116, may be used to divide the source image and distribute it to the processors.

Thus, as with the first approach (FIG. 12, the resampling tool 132 may begin by reading the source tiles from one or more secondary storage devices and perform concurrent resampling and source tile retrieval for increased speed.

Next, the resampling tool 132 determines the number of horizontal and vertical resampled pixels per resampled tile. (Step 1406). For example, the resampling tool 132 may determine the number and position of resampled pixels based on a conventional bi-linear interpolation technique. The resampling tool 132 then determines which resampled pixels are border pixels. (Step 1208). In other words, the resampling tool 132 determines which resampled pixels depend on source pixels in adjacent source tiles.

For those border pixels, the resampling tool 132 determines a first partial result that depends on the source pixels in the same source tile that the resampling tool 132 is currently resampling. (Step 1210). Alternatively, the resampling tool 132 may copy the source tile into the middle of a black image (i.e., with pixel values=0) and compute the resampled tile based on the data in the larger black image. At the border, the black pixels outside the source tile will not contribute to the bi-linear interpolation computation, thereby achieving the same result as computing the partial result. Subsequently, the resampling tool 132 (or another application program) may obtain any other partial results for the border pixel that were determined by different processors or image processing systems. (Step 1212). The application may then combine the partial results to determine the resampled pixel. (Step 1214). With all of the resampled pixels determined, the application may then merge all the resampled pixels into a single resampled image. (Step 1216). For example, the resampling tool 132 may merge all the resampled pixels into the output image 118 for further processing by the image generation tool 116 as discussed above.

D. Sharing Digital Content Across A Communication Network

As discussed above, the image sharing server 140 significantly reduces the time and cost for a person using the image processing system 100 to share an image (e.g., digital content of the original image 60) across the network 54 with another person using the client computer 52. For example, the image sharing server 140 minimizes the number of disk accesses (e.g., secondary storage 108), the amount of memory 106, and the amount of data transferred to the client computer 52 to share the image across the network 54 with the client computer 52. In addition, the image sharing server 140 allows the person sharing the original image to maintain control of the image.

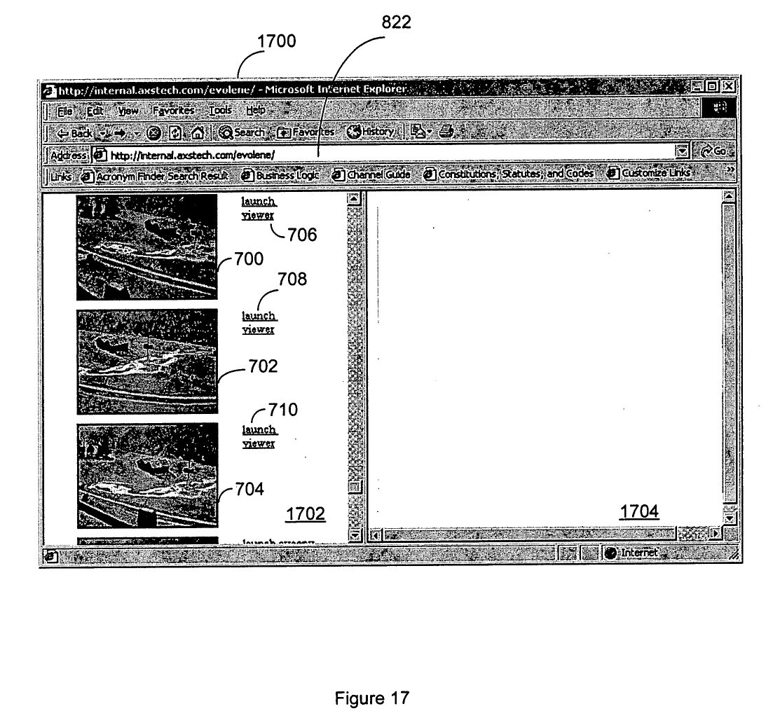

Turning to FIG. 16, that figure depicts a flow diagram illustrating an exemplary process performed by the image sharing server 140 to share an image on the image processing system (e.g., a first computer) across the Internet (which is network 54 for this example) with the client computer 52. As discussed below, a person using the image processing system 100 to share an original image (e.g., original image 60) via the image sharing server 140 and another person using the client computer 52 to request access to the original image in accordance with the present invention will both access various user interfaces, which may take the general form depicted in FIGS. 7, 8, and 17 through 21. These figures suggest the use of Java applets in a WINDOWS 9x environment. Of course, while the present disclosure is being made in a Java/WINDOWS 9x type environment, use of this environment is not required as part of the present invention. Other programming languages and user-interface approaches may also be used to facilitate data entry and execute the various computer programs that make up the present invention.

Initially, the image sharing server 140 associates a multi-resolution representation of an original image with a web page. (Step 1602). For example, the image sharing server may perform the process 300 (See FIG. 3) to generate the multi-resolution representation 120 of original image 60 and to generate the web page 144 having the address 822 (See FIG. 8) when the original image 60 is identified to the image sharing server 140 as the image to be shared. As previously described, when performing the process 300, the image sharing server 140 may generate an output image 118 to associate with the web page 144.

Next, the image sharing server 140 receives the address of the client computer 52. (Step 1604). The address of the client computer 52 may be an Internet Protocol (“IP”) address or other network address. The image sharing server may receive the address of the client computer 52 from a person using the image processing system 100 via any known data input technique, such as via keyboard 112 entry or via a file (not shown) on secondary storage 108 that has a list of addresses of client computers authorized to have access to the original image 60 in accordance with this invention.

The image sharing server 140 may then provide the address of the web page 144 to the client computer. (Step 1606) In one implementation, the image sharing server may provide the address 822 of the web page 144 by invoking the message tool 138 to send an e-mail or an instant message containing the web page 144 address 822 to the messaging tool 56 of the client computer 52. The image sharing server may automatically invoke or cause the message tool 138 to send the web page address 822 to the client computer 52 in response to receiving the client computer address.

After providing the web page address to the client computer, the image sharing server 140 determines whether the web page 144 has been accessed. (Step 1608). Although not depicted, as would be understood by one skilled in the art, the image sharing server 140 may perform other functions (e.g., perform other process threads in parallel) while checking if the web page 144 has been accessed. If its determined that the web page 144 has been accessed, the image sharing server 140 generates an output image based on the associated multi-resolution representation 120 of the original image 60 associated with the web page 144. (Step 1610). In one implementation, the image sharing server 140 produces the output image 118 by invoking the image generation tool 116 to perform the process described above in conjunction with FIG. 9. In another implementation, the image sharing server 140 may retrieve predefined control image parameters stored by the image sharing server 140 in association with the web page 144 as described above in reference to process 300 (See FIG. 3.) In this implementation, if the image sharing server 140 determines that the starting resolution of the image control parameters corresponds to one of the image entries (122, 124, or 126), then the image sharing server may provide the output image 118 to the client computer 52 by accessing the multi-resolution image 120 without invoking the image generation tool 116. In another implementation, the image sharing server 140 may provide the output image 118 generated in step 320 of FIG. 3, which may have been cached by the image sharing server 140 when performing process 300 to generate the web page 144.

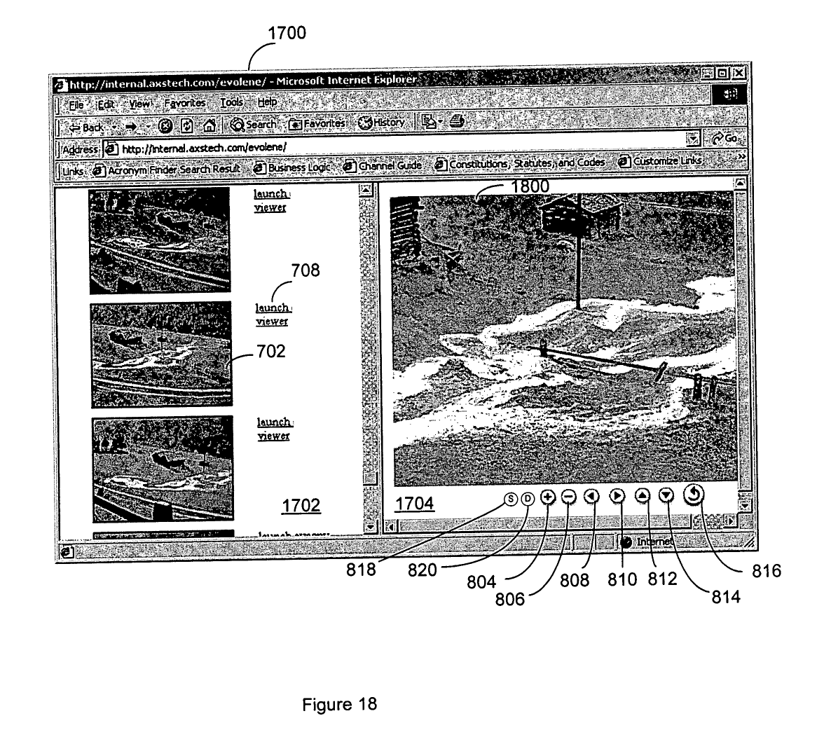

Next, the image sharing server 140 provides the output image 118 to client computer 52 (Step 1612). The image sharing server 140 via the web server 134 may provide the output image 118 in one or more files in any known format (e.g., plain text with predefined delimiters, HyperText Markup Language (HTML), Extensible Markup Language (XML), or other Web content format languages) to the client computer 52 in response to the client computer 52 request to access the web page 144. The files are interpreted by the web browser 58 such that the output image 118 may then be viewed by the web browser 58 of the client computer 52. FIG. 17 depicts an exemplary user interface 1700 displayed by the web browser 58 of the client computer after accessing the web page 144 and receiving the output image 118 from the image sharing server 140. In the implementation shown in FIG. 17, the image sharing server 140 causes the web browser 58 of the client computer 52 to display in a panel 1702 (similar to panel 402 of FIG. 4B) the output image 700, 702, and 704 in association with the corresponding selection 706, 708, and 710. Each displayed output image 700, 702, and 704 corresponds to a respective output image 118 generated by the image sharing server 140 as discussed above. Thus, the image sharing server 140 is able to cause the user interface 1700 of the client computer 52 to be the same as the display 400 associated with the web page 144 on the image processing system 100.

Returning to FIG. 16, the image sharing server 140 then determines whether the output image has been selected by the client computer 52. (Step 1614). If it is determined that the output image (e.g., 700, 702, or 704) has not been selected, the image sharing server 140 continues processing at step 1634. If it is determined that the output image (e.g., 700, 702, or 704) has been selected, the image sharing server 140 may generate another output image having a different resolution based on the multi-resolution representation. (Step 1616) and provide the other output image to the client computer 52. (Step 1618).

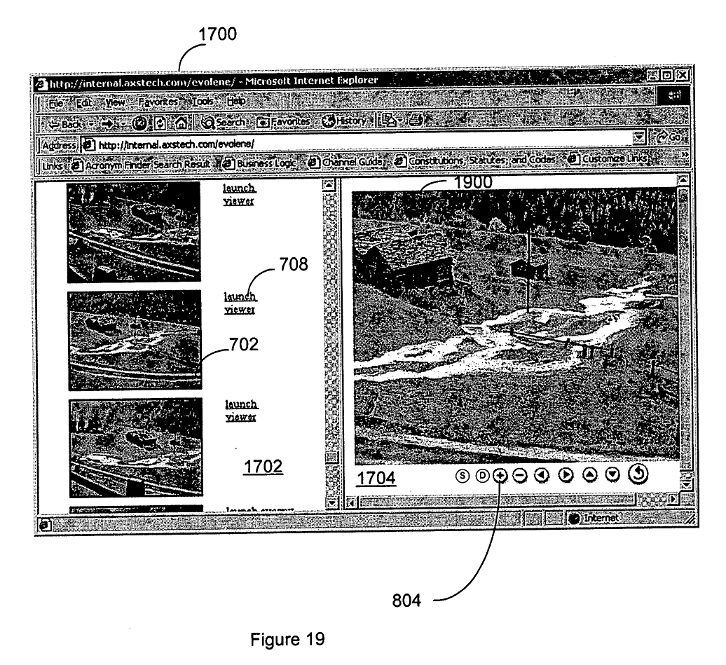

For example, assuming that a person viewing the output images 700, 702, or 704 on client computer 52 presses selection 708 (see FIG. 17) corresponding to output image 702, a request to view the output image 702 in an expanded view may be sent by the client computer 52 to the image sharing server 140 on the image processing system 100. As shown in FIG. 18, the image sharing server may then generate the other output image 1800 by invoking the image generation tool 116 to generate the other output image 1800 so that the other output image has the expanded size specified by the image control parameters stored in association with the web page 144. Thus, the image sharing server 140 enables the person using the image processing system 100 to control the digital content (i.e., output image 702 or other output image 1800) of the original image 60 that is shared with another person using client computer 52.

Next, the image sharing server 140 determines whether a resize option has been requested. (Step 1620). In the implementation shown in FIG. 18, the person accessing web page 144 from the client computer 52 may select resize option 804 (e.g., “zoom in”), 806 (e.g., “zoom out”), 808 (e.g., “pan left”), 810 (e.g., “pan right”), 812 (e.g., “pan up”), 814 (e.g., “pan down”), and 816 (e.g., “reset”) to cause a corresponding request to be sent from the client computer 52 to the image sharing server on the image processing system 100. If a resize option has not been selected, the image sharing server 140 continues processing at step 1626.

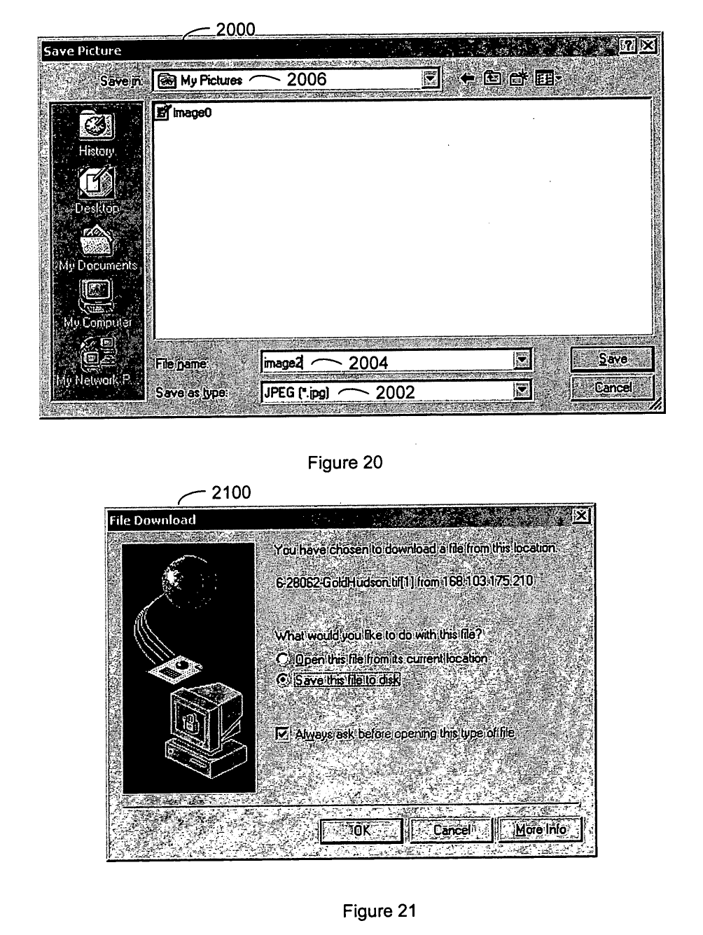

If a resize option has been requested, the image sharing server 140 resizes the output image 1800 to reflect the resized option request (Step 1622) and provides the resized output image to the client computer 52. (Step 1624). In the example shown in FIG. 19, the image sharing server 140 resized the output image 1800 to generate a new output image 1900 to replace the output image 1800 in response to the user selection of resize option 804 to “zoom in” on the output image 1800. The image sharing server 140 may use other tiles 128 of another image entry 122, 124, or 126 to process the requested resize option 804—or to process other requested resize options 806 (e.g., “zoom out”), 808 (e.g., “pan left”), 810 (e.g., “pan right”), 812 (e.g., “pan up”), 814 (e.g., “pan down”). The image sharing server 140 may also invoke the resampling tool 132 alone or in combination with the image generation tool 116 to generate the output image 1900 in accordance with methods and systems consistent with the present invention.

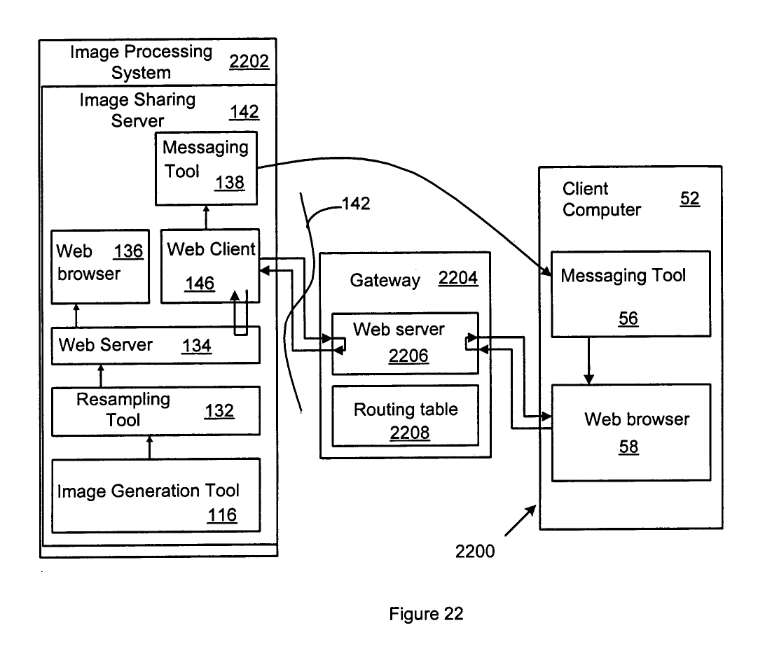

The image sharing server 140 also determines whether the save option 818 has been requested. (Step 1626). If it is determined that the save option 818 has not been selected, the image sharing server 140 continues processing at step 1630. If the save option 818 has been selected, the image sharing server 140 receives a corresponding request and saves the other output image 1900 or resized image to the client computer 52. (Step 1628). To save the displayed output image the image sharing server 140 may invoke the operating system of the client computer 52 using known file management calls or application program interface commands to save the output image 1800 or the resized output image 1900 on the client computer 52. FIG. 20 depicts an exemplary user interface 2000 displayed by client computer 52 for saving the output image 1800 or the resized output image 1900 on the client computer 52. The image sharing server 140 may cause to the client computer 52 to generate the user interface 2000 when the save option 818 is selected. The image sharing server 140 may cause the output image 1800 or 1900 to be stored in the base format associated with the multi-resolution representation of the original image 60. Alternatively, as shown in FIG. 20, the image sharing server 140 may convert the output image 1800 or 1900 to another known format 2002, such as *.tiff or *.jpeg before saving the displayed output image 1800 or 1900 in a file having a name 2004 and at a location 2006. Accordingly, the image sharing server 140 allows the person using the client computer 52 to alter the view of the output image 1800 and then save the altered output image 1900 on the client computer 52 without having to download the high resolution original image 60 (e.g.. 2024×2024 pixels or larger).

Returning to FIG. 16, the image sharing server 140 also determines whether the download option 820 (FIG. 18) has been requested. (Step 1630). If the download option 820 has not been selected, the image sharing server 140 continues processing at step 1634.

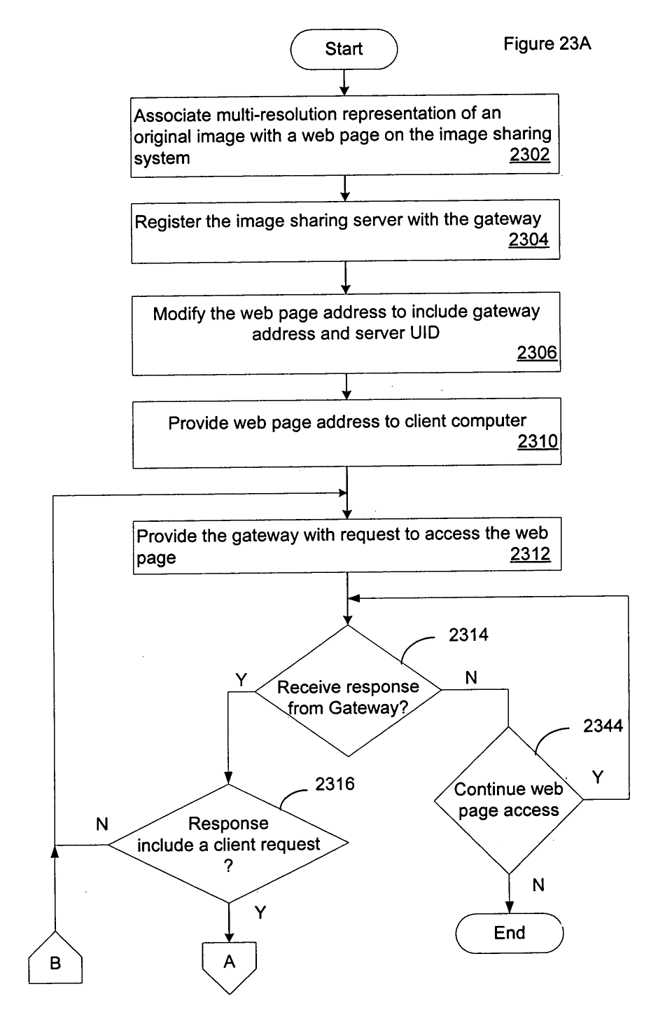

If the download option 820 has been selected, the image sharing server 140 downloads the original image 60 to the client computer 52. (Step 1632). FIG. 21 depicts an exemplary user interface 2100 displayed by client computer 52 for downloading the original image 60 to the client computer 52. The image sharing server 140 may cause to the client computer 52 to generate the user interface 2100 when the download option 820 is selected.

Next, the image sharing server 140 determines whether to continue access to web page 144. (Step 1634). The image sharing server 140 may determine whether to continue access based on the web browser 58 of the client computer 52 closing the user interface 1700 or based the image sharing server not receiving any request from the web browser 58 within a predefined time limit. If it is determined that access to the web page 144 is to continue, the image sharing server continues processing at step 1620. If it is determined that access to the web page 144 is not to continue, processing ends.

FIG. 22 depicts a block diagram of another embodiment of an image processing system and sharing system 2200 suitable for practicing methods and implementing systems consistent with the present invention. As shown in FIG. 22, image processing and sharing system 2200 includes an image processing system 2202 operably connected to a router or gateway 2204.

The image processing system 2202 has an associated firewall 142 that may be stored on the image processing system 2202 or on the gateway 2204. The firewall 142 controls communication access to the image processing system 2202 on the network 54, such that the client computer 52 is not able to directly access the web page 144 across the network 54. The gateway 2204 operably connects the client computer 52 to the image processing system 2202 and is configured to route a registered request between the client computer 52 and the image processing system 2202.

The gateway 2204 has a conventional web server 2206 and a routing table 2208. The web server 2206 is operably configured to receive and process a registration request from the image sharing server 140. The registration request may include a unique identification mechanism (UID) for the image sharing server 140 and associated commands or requests that the client computer 52 may generate and that the image sharing server 140 is configured to handle. The gateway 2204 registers requests for the imaging sharing server 140 by storing the UID of the imaging sharing server 140 and the requests that the server 140 handles in the routing table 2208.

Similar to image processing system 100, the image processing system 2200 includes an image sharing server 142 operably configured to control an image generation tool 116, a resampling tool 132, a web server 134, a web browser 134, and a messaging tool 138. The image processing system 2200 also includes a web client 146 that is operably connected between the web server 134 and the firewall 142. The web client 146 is operably configured to send network requests, such as an http or URL request, originating from the web server 134 to the gateway 2004 on network 54. The web client 146 is also configured to interpret request results for the web server 134.

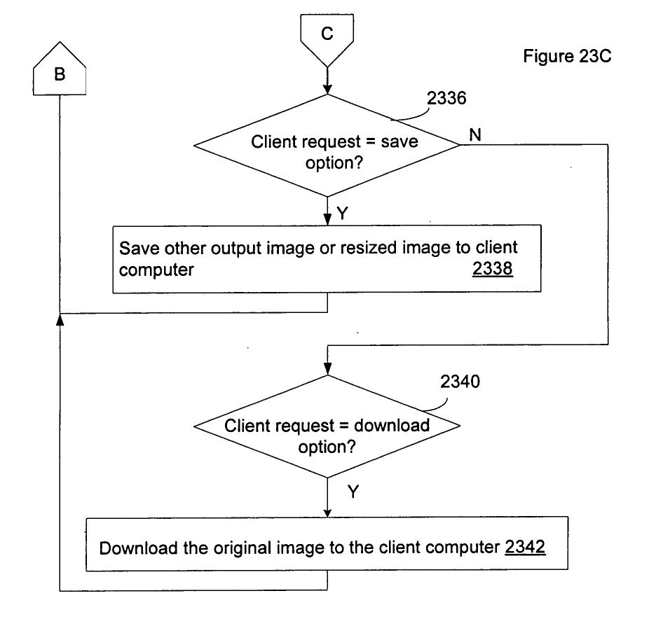

FIGS. 23A-C depict a flow diagram illustrating an exemplary process performed by the image sharing server 140 to share an image on the image processing system 2200 (e.g., a first computer) across the network 54 with the client computer 52 when the image processing system 2200 has a firewall 142.

Initially, the image sharing server 140 associates the multi-resolution representation of an original image with a web page on the image sharing system. (Step 2302). For example, the image sharing server would perform the process 300 of (See FIG. 3) to generate the multi-resolution representation 120 of original image 60 and to generate the web page 144 having the address 822 (See FIG. 8) when the original image 60 is identified to the image sharing server 140 as the image to be shared. As previously described, when performing the process 300, the image sharing server 140 generates an output image 118 to associate with the web page 144.

Next, the image sharing server 140 registers itself with the gateway 2204. (Step 2304). For example, the image sharing server 140, via web client 136, may provide the gateway 2204 with a registration request that includes the UID of the image sharing server 140 and each of the commands and requests that the image sharing server 140 is configured to handle, such as a request to access web page 144 and other requests associated with the web page 144 (e.g., resize, save, and download option requests).

After registering with the gateway, the image sharing server 140 modifies the address of web page 144 to include the gateway address and UID of the image sharing server. (Step 2306). The image sharing server 140 then provides the modified web page address to the client computer. (Step 2310). In one implementation, the image sharing server may provide the address 822 of the web page 144 by invoking the message tool 138 to send an e-mail or an instant message containing the web page address 822 to the messaging tool 56 of the client computer 52.

Next, the image sharing server 140 provides the gateway with a request to access the web page. (Step 2312). The gateway 2204 may block the request from the image sharing server 140 for a predetermined time period while the gateway 2204 awaits for a corresponding request originating from the client computer 52 in accordance with the registered requests for the image sharing server stored in routing table 2208. In such event, the gateway 2204 may provide an empty response to the image sharing server 140 if a request originating from the client computer 52 is not received within the predetermined time period or provide a response that includes the request originating from the client computer 52.

The image sharing server 140 then determines whether a response has been received from the gateway 2204. (Step 2314). The image sharing server 140 may perform other functions (e.g., perform other process threads in parallel) while checking if the a response has been received. If its determined that a response has been received, the image sharing server 140 determines whether the response includes a client request (Step 2316). If the response does not contain a client request, the image sharing server 140 continues processing at step 2312 so that a request to access the web page 144 is pending at the gateway 2204. In one implementation, the web client 146 is configured to receive a response from the gateway 2204 and forward any request from the client computer 52 that is included in the response to the web server 134. The image sharing server 140 via the web server 134 may then respond to the request from the client computer 52 to access web page 144.

Turning to FIG. 23B, if the response includes a client request, the image sharing server 140 determines whether the client request is a request to access the web page 144. (Step 2318). The image sharing server may use the web client 146 to receive the response from the gateway 2204 and to identify if the response contains a client request from the client computer 52. The web client 146 may then pass the client request to the web server 134 for further processing under the control of the image sharing server 140. The web server 134 may be operably configured to parse a client request, such that the web server 134 is able to identify the client request (e.g., access to web page 144 requested, resize option requested, or download option requested). The image sharing server 140, via the web server 134, is operably configured to respond to the client request as described below.

If it is determined that the client request is to access the web page 144, the image sharing server 140 generates an output image based on the associated multi-resolution representation 120 of the original image 60 associated with the web page 144. (Step 2320). In one implementation the image sharing server 140 produces the output image 118 by invoking the image generation tool to perform the process described in association with FIG. 9. In another implementation, the image sharing server 140 may retrieve predefined control image parameters stored by the image sharing server 140 in association with the web page 144 as described above in reference to process 300 of (FIG. 3). In this implementation, if the image sharing server 140 determines that the starting resolution of the image control parameters corresponds to one of the image entries (122, 124, or 126), then the image sharing server may provide the output image 118 to the client computer 52 by accessing the multi-resolution image 120 without invoking the image generation tool 116. In another implementation, the image sharing server 140 may provide the output image 118 generated in step 320 of FIG. 3, which may be cached by the image sharing server 140 when performing process 300 to generate the web page 144.

Next, the image sharing server 140 provides the output image 118 to the client computer 52 (Step 2322). In the implementation shown in FIG. 22, the image sharing server 140, via the web server 134, provides the output image 118 in one or more corresponding files having any known format (e.g., html or xml, or other equivalent web content formats) to the web client 136. The web client 136 is operably configured to send a network transmission request (e.g., a URL request addressed to the client) containing the one or more corresponding files to the gateway 2204 in response to the client computer 52 request to access the web page 144. The gateway 2204 is operably configured to subsequently provide a response to the client computer 52 that contains the one or more documents corresponding to the output image 118.

The corresponding files may be interpreted by the web browser 58 of the client computer 52 using conventional techniques, such that the output image 118 may then be viewed by the web browser 58. For example, FIG. 17 depicts an exemplary user interface 1700 displayed by the web browser 58 of the client computer 52 after accessing the web page 144 and receiving the output image 118 from the image sharing server 140. In the implementation shown in FIG. 17, the image sharing server 140 causes the web browser 58 of the client computer 52 to display in a panel 1702 (similar to panel 402 of FIG. 4B) the output image 700, 702, and 704 in association with the corresponding selection 706, 708, and 710. Each displayed output image 700, 702, and 704 corresponds to a respective output image 118 generated by the image sharing server 140 as discussed above. Thus, the image sharing server 140 is able to cause the user interface 1700 of the client computer 52 accessing the web page 144 to be the same as the display 400 associated with the web page 144 on the image processing system 2202 when the image processing system 2202 has a firewall 142.

After the image sharing server 140 provides the output image 118 to the client computer 52, the image sharing server 140 continues processing at step 2312 (FIG. 23A) so that the image sharing server 140 is prepared to handle another client request associated with web page 144.

If the client request is not a request to access the web page 144 (e.g., web page 144 has been previously accessed by the client computer 52), the image sharing server 140 determines whether the client request indicates that the output image 118 has been selected. (Step 2324, FIG. 23B). If the client request indicates that the output image 118 has been selected, the image sharing server 140 generates another output image having a different resolution based on the multi-resolution representation (Step 2326) and provides the other output image to the client computer 52 (Step 2328). For example, assuming that a person viewing the output images 700, 702, or 704 (FIG. 18) on client computer 52 presses selection 708 corresponding to output image 702, a client request indicating that the output image 702 has been selected may be sent by the client computer 52 to the image sharing server 140 on the image processing system 100. As depicted by FIG. 18, the image sharing server may then generate the other output image 1800 by invoking the image generation tool 116 to generate the other output image 1800 so that the other output image has the expanded size specified by the image control parameters stored in association with the web page 144. The image sharing server 140 may then allow the client computer 52 to receive other image 1800 that has a higher resolution than the output image 702. Thus, the image sharing server 140 enables the person using the image processing system 100 to control the digital content (i.e., output image 702 or other output image 1800) of the original image 60 that is shared with another person using client computer 52.

If the client request does not indicate that the output image has been selected (e.g., output image 702 has been previously been selected by the client computer 52), the image sharing server 140 determines whether the client request indicates that a resize option has been selected. (Step 2330). As discussed above, in association with the implementation shown in FIG. 18, the person accessing web page 144 from the client computer 52 may select resize option 804 (e.g., “zoom in”), 806 (e.g., “zoom out”), 808 (e.g., “pan left”), 810 (e.g., “pan right”), 812 (e.g., “pan up”), 814 (e.g., “pan down”), and 816 (e.g., “reset”) to cause a corresponding request to be sent from the client computer 52 to the image sharing server on the image processing system 100.

If a resize option has been requested, the image sharing server 140 resizes the output image 1800 to reflect the resized option request (Step 2330) and provides the resized output image to the client computer 52. (Step 2332). FIG. 19 shows where the image sharing server 140 resizes the output image 1800 (FIG. 18) generating another output image 1900 to replace the output image 1800 in response to the resize option 804 to “zoom in” on the output image 1800. The image sharing server 140 may use other tiles 128 of another image entry 122, 124, or 126 to process the requested resize option 804—or to process other requested resize options 806 (e.g., “zoom out”), 808 (e.g., “pan left”), 810 (e.g., “pan right”), 812 (e.g., “pan up”), 814 (e.g., “pan down”). The image sharing server 140 may also invoke the resampling tool 132 alone or in combination with the image generation tool 116 to generate the output image 1900 in accordance with methods and systems consistent with the present invention.

Turning to FIG. 23C, if the client request does not indicate that a resize option has been selected, the image sharing server 140 determines whether the client request indicates that the save option 818 has been selected. (Step 2336). If the save option 818 has been selected, the image sharing server 140 causes the output image 802 or the other output image 1900 (the resized output image) to be saved on the client computer 52. (Step 2338). To save the displayed output image the image sharing server 140 may, via a network transmission request routed through the gateway 2202, use known file management calls or application program interface commands to cause the operating system of the client computer 52 to save the output image 1800 or the resized output image 1900 on the client computer 52. FIG. 20 depicts an exemplary user interface 2000 displayed by client computer 52 for saving the output image 1800 or the resized output image 1900 on the client computer 52. The image sharing server 140 may cause to the client computer 52 to generate the user interface 2000 when the save option 818 (FIG. 18) is selected. The image sharing server 140 may cause the output image 1800 or 1900 to be stored in the base format associated with the multi-resolution representation of the original image 60. Alternatively, as shown in FIG. 20, the image sharing server 140 may convert the output image 1800 or 1900 to another known format 2002, such as *.tiff or *.jpeg before saving the displayed output image, before saving the output image 1800 or 1900 in a file having a name 2004 and at a location 2006. Accordingly, the image sharing server 140 allows the person using the client computer 52 to alter the view of the output image 1800 and then save the altered output image 1900 on the client computer 52 without having to download the high resolution original image 60 (e.g. 2024×2024 pixels or larger).

If the client request does not indicate that the save option 818 has been selected, the image sharing server 140 determines whether the client request indicates that the download option 820 has been selected. (Step 2340). If the download option 820 has been selected, the image sharing server 140 downloads the corresponding original image 60 to the client computer 52. (Step 2342). The image sharing server 140 may download the original image 60 via one or more network transmission requests through the gateway 2204.

Returning to FIG. 23A, if it is determined that a response has been received from the gateway 2204, the image sharing server 140 determines whether to continue web page access. (Step 2344). The image sharing server 140 may determine whether to continue access based on the image sharing server 140 not receiving a response from the gateway 2204 within a predefined time limit. If it is determined that access to the web page 144 is to continue, the image sharing server 140 continues processing at step 2312. If it is determined that access to the web page 144 is not to continue, processing ends.

The foregoing description of an implementation of the invention has been presented for purposes of illustration and description. It is not exhaustive and does not limit the invention to the precise form disclosed. Modifications and variations are possible in light of the above teachings or may be acquired from practicing of the invention. As one example, different types of multi-resolution representations (e.g., Flashpix or JPEG2000) may be used within the teaching of this invention to dynamically generate output images. Additionally, the described implementation includes software but the present invention may be implemented as a combination of hardware and software or in hardware alone. Note also that the implementation may vary between systems. The invention may be implemented with both object-oriented and non-object-oriented programming systems. The claims and their equivalents define the scope of the invention.

What is claimed is:

1. A method in an image processing and sharing system, the system having a first computer and a second computer that are each operably connected to a network, the method comprising:
generating a web page on the first computer;
generating a multi-resolution representation of an identified image;
associating the multi-resolution representation with the web page;
providing to the second computer controlled access to the multi-resolution representation via the web page on the first computer; and
providing, via the first computer, an output image associated with the multi-resolution representation to the second computer when the web page is accessed by the second computer.

2. The method of claim 1, wherein providing to the second computer controlled access to the multi-resolution representation via the web page comprises providing an address of the web page to only the second computer such that the web page on the first computer is accessible by the second computer based on the address.

3. The method of claim 1, wherein the multi-resolution representation has a plurality of image entries, each image entry having a respective one of a plurality of resolutions.

4. The method of claim 3, further comprising generating the output image based on one of the plurality of image entries.

5. The method of claim 4, wherein generating the output image further comprises:
identifying a starting resolution for the output image; and
selecting the one image entry based on the starting resolution.

6. The method of claim 5, wherein generating the output image further comprises resizing the one image entry based on the starting resolution for the output image.

7. The method of claim 6, wherein the starting resolution is different than the respective one resolution of the one image entry.

8. The method of claim 1, further comprising:
receiving an indication from the second computer that the output image is selected; and
providing, via the first computer, another output image associated with the multi-resolution representation to the second computer in response to receiving the indication.

9. The method of claim 1, wherein the other output image has a different resolution than the starting resolution.

10. The method of claim 8, wherein the resolution of the other output image corresponds to a predefined expanded view size associated with the web page.

11. The method of claim 1, further comprising:
providing a resize option to the second computer in association with the output image;
determining whether the resize option has been selected; and
providing to the second computer, via the first computer, another output image that reflects the resize option in response to selection of the resize option.

12. The method of claim 11, wherein the resize option is one of a plurality of options provided via the first computer to the second computer, the plurality of options including a zoom option and a pan option.

13. The method of claim 1, further comprising:
providing a save option to the second computer such that the second computer displays the save option in association with the output image;
determining whether the save option has been selected; and
storing the output image on the second computer in response to selection of the save option.

14. The method of claim 1, further comprising:
providing a download option to the second computer such that the second computer displays the download option in association with the output image;
determining whether the download option has been selected; and
providing the identified image to the second computer in response to selection of the download option.

15. The method of claim 1, wherein the image processing system has a gateway operably connected between the first computer and the second computer, the first computer has an associated firewall operably configured to control access to the first computer on the network, and the method further comprises:
registering an image sharing server on the first computer with the gateway;
generating an address of the web page to include an address associated with the gateway and an identification associated with the image sharing server; and
providing the address of the web page to the second computer such that the web page on the first computer is accessible by the second computer based on the address.

16. The method of claim 15, wherein providing the output image comprises:
providing the gateway with a first request from the first computer to access the web page;
receiving a response to the first request from the gateway;
determining whether the response includes a client request from the second computer to access the web page; and
providing, via the first computer, the output image to the second computer when the response includes a client request to access the web page.

17. A machine-readable medium containing instructions for controlling an image processing system to perform a method, the method comprising:
generating a web page on a first computer operably connected on a network;
generating a multi-resolution representation of an identified image stored in association with the first computer;
associating the multi-resolution representation with the web page;
providing to the second computer controlled access to the multi-resolution representation via the web page on the first computer; and
providing, via the first computer, an output image associated with the multi-resolution representation to the second computer when the web page is accessed by the second computer.

18. The machine-readable medium of claim 17, wherein providing to the second computer controlled access to the multi-resolution representation via the web page comprises providing an address of the web page to only the second computer such that the web page on the first computer is accessible by the second computer based on the address.

19. The machine-readable medium of claim 17, wherein the multi-resolution representation has a plurality of image entries, each image entry having a respective one of a plurality of resolutions, and wherein the method further comprises generating the output image based on one of the plurality of image entries.

20. The machine-readable medium of claim 19, wherein generating the output image further comprises:
identifying a starting resolution for the output image; and
selecting the one image entry based on the starting resolution.

21. The machine-readable medium of claim 20, wherein generating the output image further comprises resizing the one image entry based on the starting resolution for the output image.

22. The machine-readable medium of claim 17, further comprising:
receiving an indication from the second computer that the output image is selected;
generating another output image associated with the multi-resolution representation to the second computer in response to receiving the selection, the other output image having a resolution that is different than the starting resolution; and
providing the other output image to the second computer.

23. The machine-readable medium of claim 17, further comprising:
providing a resize option for the output image to the second computer;
determining whether the resize option has been selected; and
providing to the second computer, via the first computer, another output image that reflects the resize option in response to selection of the resize option.

24. The machine-readable medium of claim 17, providing a save option to the second computer such that the second computer displays the save option in association with the output image;
determining whether the save option has been selected; and
causing the second computer to store the output image in response to selection of the save option.

25. The machine-readable medium of claim 17, further comprising:
providing a download option to the second computer such that the second computer displays the download option in association with the output image;
determining whether the download option has been selected; and
providing the identified image to the second computer in response to selection of the download option.

26. The machine-readable medium of claim 17, wherein the image processing system has a gateway operably connected between the first computer and the second computer, the first computer has an associated firewall operably configured to control access to the first computer on the network, and the method further comprises:
registering an image sharing server on the first computer with the gateway;
generating an address of the web page to include an address associated with the gateway and an identification associated with the image sharing server; and
providing the address of the web page to the second computer such that the web page on the first computer is accessible by the second computer based on the address..

27. The machine-readable medium of claim 26, wherein providing the output image comprises:
providing the gateway with a first request from the first computer to access the web page;
receiving a response to the first request from the gateway;
determining whether the response includes a client request from the second computer to access the web page; and
providing, via the first computer, the output image to the second computer when the response includes a client request to access the web page.

28. An image processing system that is operably connected via a network to a client computer, the image processing system comprising:
a secondary storage device further comprising an image;
a memory device further comprising an image sharing program that generates a web page, that receives an identification of the image from the client computer, that generates a multi-resolution representation of the identified image in response to receiving the identification, that associates the multi-resolution representation with the web page, that provides an address of the web page to the client computer such that the web page is accessible by the client computer based on the address, and that provides an output image associated with the multi-resolution representation to the client computer when the web page is accessed by the client computer; and
a processor that runs the image sharing program.

29. The image processing system of claim 28, wherein the multi-resolution representation has a plurality of image entries, each image entry having a respective one of a plurality of resolutions.

30. The image processing system of claim 29, wherein the image sharing program further generates the output image based on one of the plurality of image entries.

31. The image processing system of claim 30, wherein, when generating the output image, the image sharing program further identifies a starting resolution for the output image, and selects the one image entry based on the starting resolution.

32. The image processing system of claim 31, wherein, when generating the output image, the image sharing program further resizes the one image entry based on the starting resolution for the output image.

33. The image processing system of claim 31, wherein the memory device further comprises a messaging tool operably controlled by the image sharing server to provide the address of the web page to the client computer over the network.

34. The image processing system of claim 31, wherein the memory device further comprises a web server operably controlled by the image sharing server to provide the output image to the client computer over the network when the web page is accessed.

35. The image processing system of claim 31, wherein the web server is operably configured to receive an indication from the client computer when the output image is selected and to provide another output image associated with the multi-resolution representation to the second computer when the indication is received, the other output image having a greater resolution than the starting resolution.

36. The image processing system of claim 35, wherein the image sharing program further provides a resize option to the client computer such that the client computer displays the resize option in association with the other output image, determines whether the resize option has been selected by the client computer, resizes the other output image to reflect the resize option when the resize option is selected, and provides the resized other output image to the client computer.

37. The image processing system of claim 35, wherein the image sharing program further provides a save option to the client computer such that the client computer displays the save option in association with the output image, determines whether the save option has been selected, and causes the output image to be stored on the client computer when the save option is selected.

38. The image processing system of claim 35, wherein the image sharing program further provides a download option to the second computer such that the client computer displays the download option in association with the output image, determines whether the download option has been selected; and provides the identified image to the client computer when the download option is selected.

39. The image processing system of claim 28, wherein memory device includes a firewall operably configured to control access to the image processing system on the network, the image processing system is operably connected to the client computer via a gateway, the image sharing program further registers the image sharing program with the gateway; and generates an address of the web page to include an address associated with the gateway and an identification associated with the image sharing server, and provides the address of the web page to the second computer such that the web page on the first computer is accessible by the second computer based on the address.

40. The image processing system of claim 36, the image sharing program further provides the gateway with a first request from the first computer to access the web page, receives a response to the first request from the gateway, determines whether the response includes a request from the client computer to access the web page, and provides the output image to the second computer when the response includes a request from the client computer to access the web page.

41. A system operably connected to a client computer via a network, the system having an image, the system comprising:
means for generating a web page;
means for generating a multi-resolution representation of an identified image;
means for associating the multi-resolution representation with the web page;
means for providing to the second computer controlled access to the multi-resolution representation via the web page on the first computer; and
providing an output image associated with the multi-resolution representation to the client computer over the network when the web page is accessed by the client computer.
